(19) United States
(12) Patent Application Publication
(10) Pub. No.: US 2024/0428523 A1
(43) Pub. Date: Dec. 26, 2024

(54) TECHNIQUES FOR SAMPLING AND REMIXING IN IMMERSIVE ENVIRONMENTS

(71) Applicant: AUTODESK, INC., San Francisco, CA (US)

(72) Inventors: David LEDO MAIRA, Toronto (CA); Fraser ANDERSON, Newmarket (CA); George William FITZMAURICE, Toronto (CA); Tovi GROSSMAN, Toronto (CA); Evgeny STEMASOV, Neu-Ulm (DE)

(21) Appl. No.: 18/391,494

(22) Filed: Dec. 20, 2023

Related U.S. Application Data
(60) Provisional application No. 63/509,503, filed on Jun. 21, 2023.

(51) Int. Cl. G06T 19/00

(52) U.S. Cl. CPC G06T 19/00; G06T 2200/24

(57) ABSTRACT

During a sampling stage, a system enables a user to capture samples of 3D digital components within an immersive environment. The 3D digital component can include a 3D object that is rendered and displayed within the immersive environment. The 3D digital components can also include object-property components used to render a 3D object, such as texture, color scheme, animation, motion path, or physical parameters. The samples of the 3D digital components are stored to a sample-palette data structure (SPDS) that organizes the samples. During a remix stage, the system enables a user to apply a sample stored to the SPDS to modify a 3D object and/or an immersive environment. The user can add a sampled object to an immersive environment to modify the immersive environment. The user can apply one or more object-based samples to a 3D object to modify one or more object properties of the 3D object.

### CROSS-REFERENCE TO RELATED APPLICATIONS

The present application claims the benefit of U.S. Provisional Application titled, “TECHNIQUES FOR SAMPLING AND REMIXING IN IMMERSIVE ENVIRONMENTS,” filed on Jun. 21, 2023, and having Ser. No. 63/509,503. This related application, including any appendices or attachments thereof, is hereby incorporated by reference in its entirety.

### BACKGROUND

### Field of the Various Embodiments

The various embodiments relate generally to computer science and immersive environments and, more specifically, to techniques for sampling and remixing in immersive environments.

### Description of the Related Art

Generally speaking, a two-dimensional (2D) computing environment is provided by a computing device that executes a 2D application implemented via a 2D interface, such as a desktop environment implemented via a desktop interface, and a three-dimensional (3D) immersive environment (IE) is provided by a computing device that executes a 3D application implemented via an IE interface, such as a virtual-reality (VR) or augmented-reality (AR) environment implemented via a VR or AR interface, respectively. Playing video games or performing productive work in 3D applications via an IE interface is becoming increasingly popular due to the distinct advantages provided by immersive environments. For example, when playing a video game or performing productive work within an immersive environment, the IE interface places the user in a more engrossing environment that allows a better sense of space and scale relative to a traditional 2D environment and 2D interface.

Sampling digital materials in 2D environments via a 2D interface is a technique typically carried out by designers as a means to collect 2D digital materials for inspiration, to help find a solution to a current design problem, and/or create a library of digital samples for possible use in later 2D environments and 2D applications. Materials that are normally sampled from 2D environments include text, images, videos and other similar 2D digital components. Similarly, conventional techniques for sampling digital materials in immersive environments involve these types of 2D digital components as well.

One drawback of conventional techniques for sampling digital materials in immersive environments is that conventional techniques are structured to sample only 2D digital components, such as text, images, and videos. Notably, there are no currently available techniques for sampling or collecting 3D digital components in immersive environments. Further, because 3D digital components currently cannot be sampled in immersive environments, the 3D digital components from one immersive environment or 3D application cannot be reused in or applied to another immersive environment or 3D application. Consequently, all 3D objects for a particular immersive environment or 3D application typically have to be designed and generated for that particular immersive environment or 3D application, including all the related 3D models and various properties of the 3D objects. Having to design and generate each 3D object for a given immersive environment or 3D application expends substantial amounts of computing resources and requires significant amounts of designer time and effort. These issues are exacerbated for immersive environments and 3D applications that include larger numbers of 3D objects.

As the foregoing illustrates, what is needed in the art are more effective techniques for sampling and reusing digital components in immersive environments.

### SUMMARY

Various embodiments include a computer-implemented method for capturing one or more samples within a three-dimensional (3D) immersive environment. The computer-implemented method includes rendering and displaying a first 3D object within a first 3D immersive environment, the first 3D object comprising at least a first component used for rendering and displaying the first 3D object. The computer-implemented method also includes capturing the at least first component as a first sample that is stored to a sample data structure.

Various embodiments include a computer-implemented method for applying one or more samples within a three-dimensional (3D) immersive environment. The computer-implemented method includes displaying a first 3D immersive environment that includes a first 3D object. The computer-implemented method also includes applying a first sample to the first 3D object to modify a first property of the first 3D object, wherein the first sample was captured from a second 3D object.

At least one technical advantage of the disclosed techniques relative to the prior art is that the disclosed techniques enable 3D digital components to be sampled and collected from immersive environments, which was not achievable using prior art approaches. Further, the disclosed techniques enable a designer/user to navigate an immersive environment, select a 3D object or other 3D digital component to be sampled and stored to a sample-palette data structure (SPDS), which can then be accessed via a sample-palette user interface (SPUI). Once accessed, the sampled 3D object or 3D digital component can be reused in or modified and applied to a different immersive environment or 3D application. In this manner, the disclosed techniques do not require a designer to design and generate each 3D object of an immersive environment or 3D application, as is the case with prior art techniques. Thus, the disclosed techniques can substantially reduce the computer resources needed to design and generate the 3D objects included in an immersive environment or 3D application and also can substantially reduce the overall amount of designer time and effort needed to create an immersive environment or 3D application. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an IE system configured to implement one or more aspects of the various embodiments;

FIG. 2 is a conceptual diagram of the IE database of FIG. 1, according to various embodiments;

FIGS. 3A-3B are conceptual diagrams of the SPDS of FIG. 1, according to various embodiments;

FIG. 4 is a screenshot of the sampling immersive environment of FIG. 1, according to various embodiments;

FIG. 5 is a screenshot of a sampling UI for a fox object displayed in the sampling immersive environment of FIG. 1, according to various embodiments;

FIG. 6 is a screenshot of a sampling UI for a chair object displayed in the sampling immersive environment of FIG. 1, according to various embodiments;

FIGS. 7A-7B are screenshots of a segmentation operation for a chair object displayed in the sampling immersive environment of FIG. 1, according to various embodiments;

FIG. 8 is a screenshot of a single-color UI displayed in the sampling immersive environment of FIG. 1, according to various embodiments;

FIG. 9 is a screenshot of a color-palette UI displayed in the sampling immersive environment of FIG. 1, according to various embodiments;

FIG. 10 is a screenshot of suggestion windows displayed in the sampling immersive environment of FIG. 1, according to various embodiments;

FIG. 11 illustrates a sample collection menu of the SPUI of FIG. 1, according to various embodiments;

FIG. 12 illustrates an object collection UI of the SPUI of FIG. 1, according to various embodiments;

FIG. 13 illustrates a texture collection UI of the SPUI of FIG. 1, according to various embodiments;

FIG. 14 illustrates a color-scheme collection UI of the SPUI of FIG. 1, according to various embodiments;

FIG. 15 illustrates an animation collection UI of the SPUI of FIG. 1, according to various embodiments;

FIG. 16 illustrates a motion collection UI of the SPUI of FIG. 1, according to various embodiments;

FIG. 17 illustrates a physical-parameters collection UI of the SPUI of FIG. 1, according to various embodiments;

FIG. 18 illustrates a single-color and color-palette collections UI of the SPUI of FIG. 1, according to various embodiments;

FIGS. 19A-19B set forth a flow diagram of method steps for capturing samples within a 3D immersive environment and viewing samples in an SPUI, according to various embodiments;

FIG. 20 is a screenshot of a remix IE selection menu displayed in the sampling immersive environment of FIG. 1, according to various embodiments;

FIG. 21 is a screenshot of the remix immersive environment of FIG. 1, according to various embodiments;

FIG. 22 is a screenshot of a sampled object added to the remix immersive environment of FIG. 1, according to various embodiments;

FIG. 23 is a screenshot of additional sampled objects added to the remix immersive environment of FIG. 1, according to various embodiments;

FIG. 24 is a screenshot of a first object selected for remixing within the remix immersive environment of FIG. 1, according to various embodiments;

FIGS. 25A-25B are close-up screenshots of a remixed first object within the remix immersive environment of FIG. 1, according to various embodiments;

FIG. 26 is a screenshot of a first object selected for remixing with a second object within the remix immersive environment of FIG. 1, according to various embodiments;

FIG. 27 is a screenshot of an animation property being transferred to the first object within the remix immersive environment of FIG. 26, according to various embodiments;

FIG. 28 is a screenshot of a completed animation property transfer to the first object within the remix immersive environment of FIG. 27, according to various embodiments;

FIG. 29 is a screenshot of an initiated color-palette remix of multiple objects within the remix immersive environment of FIG. 1, according to various embodiments;

FIG. 30 is a screenshot of a completed color-palette remix of multiple objects within the remix immersive environment of FIG. 29, according to various embodiments;

FIG. 31 is a screenshot of a sampled chair object added to the remix immersive environment of FIG. 1, according to various embodiments;

FIG. 32 is a screenshot of a “peek” revisit function applied to the sampled chair object of FIG. 31, according to various embodiments;

FIG. 33 is a screenshot of a “full immersion” revisit function applied to the sampled chair object of FIG. 31, according to various embodiments; and

FIG. 34 sets forth a flow diagram of method steps for reusing samples within a 3D immersive environment, according to various embodiments.

### DETAILED DESCRIPTION

In the following description, numerous specific details are set forth to provide a more thorough understanding of the various embodiments. However, it will be apparent to one of skilled in the art that the inventive concepts can be practiced without one or more of these specific details.

As used herein, an “IE interface” comprises 3D-specific hardware and software components for interacting with a 3D immersive environment (IE). For example, 3D hardware can include a 3D display, one or more 3D controllers that operate in 3D, one or more tracking devices, and one or more cameras. For example, 3D software can include a IE engine that generates a 3D immersive environment and displays a 3D immersive scene on a 3D display. The 3D immersive scene comprises a particular view of the 3D immersive environment. Examples of IE interfaces include a virtual-reality (VR) interface and an augmented reality (AR) interface.

As used herein, an “immersive environment” (IE) comprises a computer-generated 3D environment that includes one or more selectable 3D objects. The 3D display can display a 3D immersive scene (such as a VR scene or AR scene) comprising a particular view of the immersive environment, depending on the position/location of the user viewpoint within the immersive environment. An immersive environment comprises one or more IE scenes, each IE scene comprising a particular sub-portion of the immersive environment that is currently displayed and viewed in the 3D display. Examples of a 3D immersive environment include a virtual environment generated by a VR interface, an augmented environment generated by an AR interface, augmented spaces with projections or displays (such as the immersive Van Gogh experience), and the like.

As used herein, a “3D object” comprises a computer-generated 3D digital component within an immersive environment. A 3D object comprises a 3D model and one or more object properties. An object property of a 3D object includes, without limitation, texture, color scheme, animation, motion, and physical parameters. An object property of a 3D object comprises a 3D digital component that is used to render the 3D object.

As used herein, a “sample of a 3D digital component” comprises the capturing, recording, and/or logging of metadata associated with the 3D digital component from within an immersive environment. The 3D digital components that can be sampled include object-based samples and color-based samples.

As used herein, “object-based samples” include an object sample and object property samples. An object sample comprises metadata for an entire 3D object including, without limitation, a 3D model, texture, color scheme, animation, motion, and physical parameters of the 3D object. An object property sample comprises metadata for a specific property of a particular 3D object, including without limitation, texture metadata, color-scheme metadata, animation metadata, motion path metadata, or physical parameters metadata of the particular 3D object. An object property sample of a specific property of a particular 3D object is separate and distinct from an object sample of the particular 3D object. The metadata of an object-based sample can be used to render the entire object (in the case of an object sample), or render a specific property of an object (in the case of an object property sample).

As used herein, “color-based samples” include a single-color sample and a color-palette sample. A single-color sample comprises metadata for a single color associated with a specific point/location within the immersive environment. A color-palette sample comprises metadata for multiple colors associated with multiple 3D objects.

As used herein, a “sample-palette data structure” (SPDS) comprises a data structure that stores, collects, and organizes the samples of the 3D digital components. As used herein, a “sample-palette user interface” (SPUI) comprises a user interface for accessing and viewing samples collected and organized in the SPDS. The collected samples can be accessed via the SPUI to reuse/apply the samples to generate new 3D objects, new immersive environments, and/or new 3D applications. Reusing a sample includes using an object sample of a 3D object from a first immersive environment to add the 3D object to a second immersive environment to generate a modified/new immersive environment. Reusing a sample also includes modifying a property of a 3D object using a sample to generate a modified/new 3D object, referred to as “remixing.”

Advantageously, the disclosed techniques enable 3D digital components to be sampled and collected from immersive environments, as opposed to the sampling of only 2D digital components from immersive environments provided by conventional techniques. As a designer/user navigates an immersive environment, the designer can select 3D objects and other 3D digital components to be sampled and stored to a sample-palette data structure (SPDS) that collects and organizes the sampled 3D digital components. The sampled 3D digital components can then be accessed via a sample-palette user interface (SPUI) that enables a user to view and reuse/apply sampled 3D digital components to modify 3D objects, immersive environments, and/or 3D applications in order to generate and render new 3D objects, new immersive environments, and/or new 3D applications. In this manner, the disclosed techniques do not require each 3D object of an immersive environment or 3D application to be originally designed and generated from the beginning to completion, as required in prior techniques. Rather, in the disclosed techniques, sampled 3D digital components can be reused to reduce or eliminate one or more designing and/or generating steps required in prior techniques. Accordingly, the disclosed techniques improve the efficiency with which 3D objects, immersive environments, and/or 3D applications can be designed and generated in regards to the expenditure of computer resources and the time and effort required by the designer, relative to prior techniques. In particular, the disclosed techniques can greatly reduce the amount of computer processing time and processing resources required to generate 3D objects, immersive environments, and/or 3D applications relative to prior techniques.

### System Overview

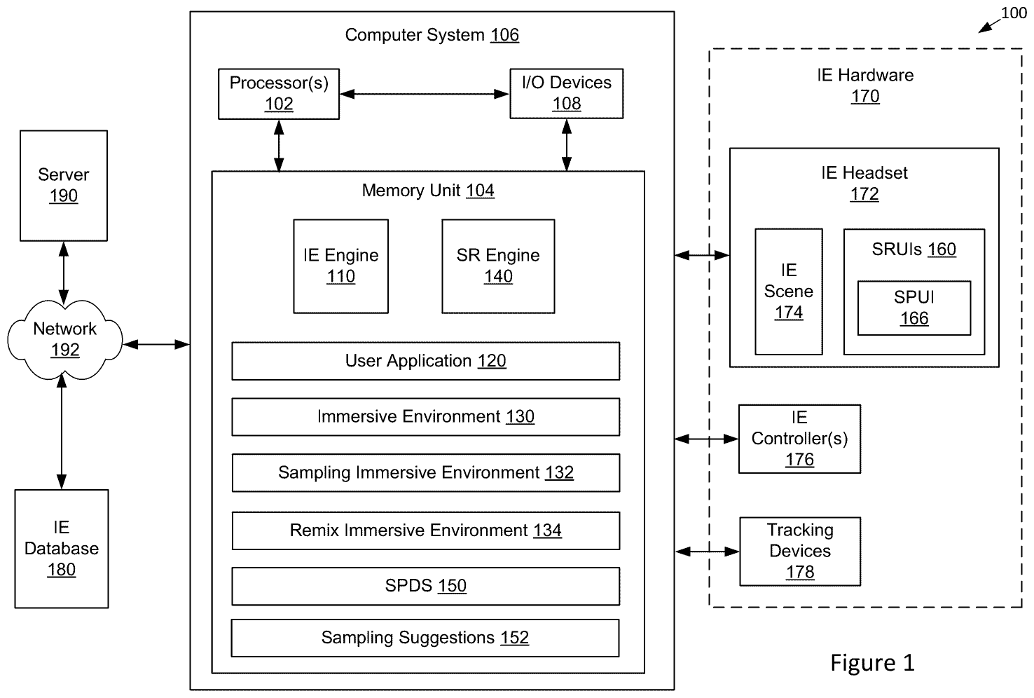

FIG. 1 illustrates an IE system 100 configured to implement one or more aspects of the various embodiments. As shown, the IE system 100 includes, without limitation, a computer system 106, an IE database 180, and a server 190 interconnected via a network 192, which may be a wide area network (WAN) such as the Internet, a local area network (LAN), or any other suitable network. A server 190 can comprise an image server comprising computer hardware (such as a processor, memory, and storage device) for storing collections of stock images/pictures and searchable metadata associated with the stock images/pictures to enable search functionality across the collections of stock images/pictures.

The computer system 106 can comprise at least one processor 102, input/output (I/O) devices 108, and a memory unit 104 coupled together. The computer system 106 can comprise a server, personal computer, laptop or tablet computer, mobile computer system, or any other device suitable for practicing various embodiments described herein. In general, each processor 102 can be any technically feasible processing device or hardware unit capable of processing data and executing software applications and program code. Each processor 102 executes the software and performs the functions and operations set forth in the embodiments described herein. For example, the processor(s) 102 can comprise general-purpose processors (such as a central processing unit), special-purpose processors (such as a graphics processing unit), application-specific processors, field-programmable gate arrays, or other programmable logic device, discrete gate or transistor logic, discrete hardware components, or any combination of different processing units.

The memory unit 104 can include a hard disk, a random access memory (RAM) module, a flash memory unit, or any other type of memory unit or combination thereof. Processor 102 and I/O devices 108 read data from and write data to memory 104. The memory unit 104 stores software application(s) and data. Instructions from the software constructs within the memory unit 104 are executed by processors 102 to enable the inventive operations and functions described herein.

I/O devices 108 are also coupled to memory 104 and can include devices capable of receiving input as well as devices capable of providing output. The I/O devices 108 can include input and output devices not specifically listed in the IE hardware 170, such as a network card for connecting with a network 192, a speaker, a fabrication device (such as a 3D printer), and so forth. Additionally, I/O devices can include devices capable of both receiving input and providing output, such as a touchscreen, a universal serial bus (USB) port, and so forth.

As shown, the computer system 106 is also connected to various IE hardware 170 including, without limitation, an IE headset 172, one or more IE controllers 176, and one or more tracking devices 178. Each IE controller 176 comprises an IE-tracked device that is tracked by the tracking devices 178 that determine 3D position/location information for the IE controller 176. For example, the IE controller 176 can comprise a 6-Degree of Freedom (6DOF) controller that operates in 3D. The IE headset 172 can display images in 3D stereo images, such as an IE scene 174 and various sampling/remix UIs (SRUIs) 160. The IE headset 172 comprises an IE-tracked device that is tracked by the tracking devices 178 that can determine 3D position/location information for the IE headset 172. In some embodiments, the tracking devices 178 track a 3D position of a user viewpoint by tracking the 3D position of the IE headset 172. In some embodiments, the IE hardware 170 comprises VR hardware 170 including, without limitation, a VR headset 172, one or more VR controllers 176, and one or more VR tracking devices 178. In other embodiments, the IE hardware 170 comprises AR hardware 170 including, without limitation, an AR headset 172, one or more AR controllers 176, and one or more AR tracking devices 178. In further embodiments, the IE hardware 170 comprises other types of IE hardware used to display and interact with other types of 3D immersive environments.

The memory unit 104 stores an IE engine 110, a sampling/remix (SR) engine 140, a user application 120, an immersive environment 130, a sampling immersive environment 132, a remix immersive environment 134, a sampling-palette data structure (SPDS) 150, and sampling suggestions 152. Although shown as separate software components, IE engine 110 and SR engine 140 can be integrated into a single software component. For example, in other embodiments, the SR engine 140 can be integrated with the IE engine 110. In further embodiments, the user application 120 and/or SR engine 140 can be stored and executed on the IE Headset 172.

The user application 120 (as stored in the memory unit 104 and executed by the processor 102 of FIG. 1) can comprise, for example, a 3D design application for creating, modifying, and interacting with the immersive environment 130. In other embodiments, the user application 120 can comprise any other type of 3D-based application, such as a 3D video game, a 3D data analysis application, and the like, which implements the immersive environment 130. The immersive environment 130 can comprise a 3D virtual environment that is stored, for example, as data describing a current scene (such as the 3D position/location, orientation, and details of virtual 3D objects), data describing a user viewpoint (3D position/location and orientation) in the virtual environment, data pertinent to the rendering of the virtual scene (such as materials, lighting, and virtual camera location), and the like.

Each immersive environment 130 is associated with a plurality of virtual 3D objects, each virtual 3D object having associated metadata used to render and display the virtual 3D object. The IE database 180 stores metadata for the virtual 3D objects for a plurality of different immersive environments 130. To render and display a particular immersive environment 130, the IE engine 110 retrieves the metadata for each virtual 3D object associated with the particular immersive environment 130 and renders and displays each associated virtual 3D object within the particular immersive environment 130 using the retrieved metadata.

An immersive environment 130 comprises a plurality of IE scenes 174, each IE scene 174 comprising a sub-portion of the immersive environment 130 that is currently displayed in the IE headset 172. The IE engine 110 renders an IE scene 174 comprising a 3D representation of the immersive environment 130. The IE scene 174 is then displayed on the IE headset 172. The user can interact with the immersive environment 130 for performing sampling and reusing/remixing of 3D digital components within the immersive environment 130 via the IE scene 174 and IE hardware 170. For example, the user can navigate within the immersive environment 130 using the IE controllers 176 and interact with and select particular 3D objects within the immersive environment 130 using a cursor ray displayed in the IE scene 174 and controlled by the IE controllers 176.

In some embodiments, the SR engine 140 (as stored in the memory unit 104 and executed by the processor 102 of FIG. 1) enables the sampling and reusing of 3D digital components within the immersive environment 130. Sampling a 3D digital component includes the capturing, recording, and/or logging of metadata associated with the 3D digital component from within the immersive environment 130. The 3D digital components that can be sampled within the immersive environment 130 include object-based samples and color-based samples. Object-based samples include an object sample and object property samples. Color-based samples include a single-color sample and a color-palette sample. The SR engine 140 stores the samples of 3D digital components to the SPDS 150, which is used to collect and organize the samples of the 3D digital components. The SR engine 140 also generates and displays a plurality of sampling/remix user interfaces (SRUIs) 160 on the IE headset 172 to enable the sampling and reusing/remixing of 3D digital components. The SRUIs 160 include a sample-palette user interface (SPUI) 166 for accessing and viewing samples collected and organized in the SPDS 150 for reusing/remixing the samples to generate new 3D objects, new immersive environments, and/or new 3D applications.

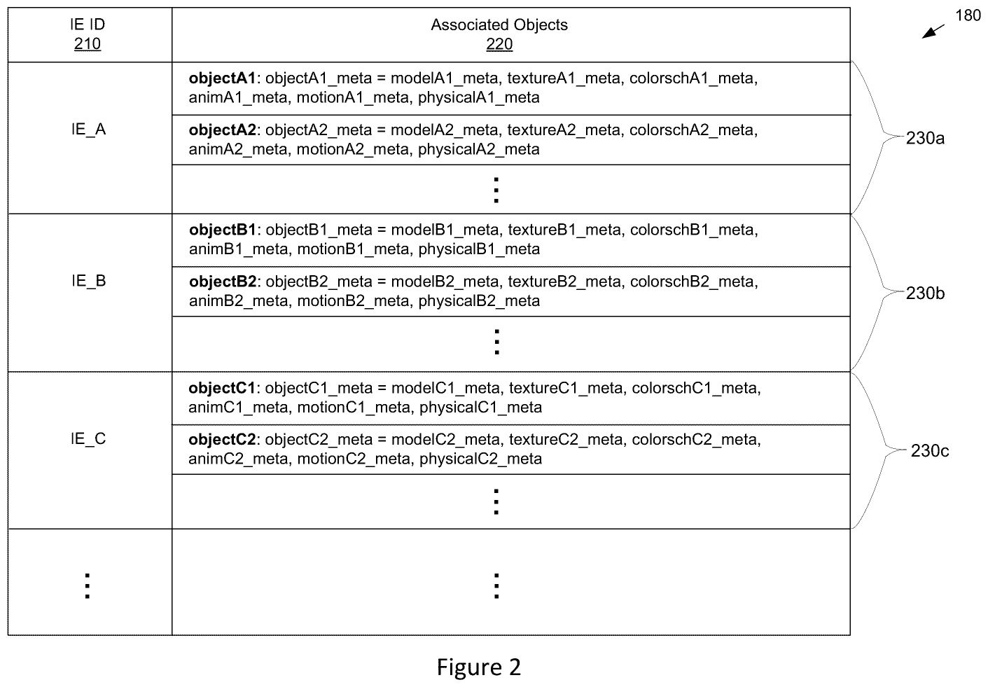

FIG. 2 is a conceptual diagram of the IE database 180 of FIG. 1, according to various embodiments. The IE database 180 stores metadata for a plurality of different immersive environments 130 (such as IE_A, IE_B, IE_C). The IE database 180 comprises a plurality of IE entries 230 (such as 230a, 230b, 230c), each IE entry 230 representing a particular immersive environment 130 and storing metadata for the represented immersive environment 130. Each IE entry 230 includes an identifier field 210 and an associated objects field 220. The IE identifier field 210 specifies an IE identifier that uniquely identifies the IE entry 230 and the represented immersive environment 130 (such as IE_A, IE_B, IE_C). The associated objects field 220 specifies one or more 3D objects associated with the represented immersive environment 130. The associated objects field 220 includes unique object identifiers for each of the one or more associated 3D objects, such as objectA1, objectA2, objectA3, etc. An immersive environment 130 can be defined by the 3D objects that are associated with the immersive environment 130. As such, a first immersive environment 130 having a different set of associated 3D objects from a second immersive environment 130 can be considered a separate and distinct immersive environment 130, even when the set of associated 3D objects only differ by a single 3D object.

The associated objects field 220 also comprises metadata for each 3D object associated with the represented immersive environment 130 (such as objectA1_meta, objectA2_meta, objectA3_meta, etc.). The metadata stored for a 3D object in the associated objects field 220 comprises metadata that defines the 3D object and is used to render and display the 3D object. The metadata stored for each 3D object (object_meta) includes metadata for a 3D model of the 3D object and metadata for one or more object properties (texture, color scheme, animation, motion, and/or physical parameters).

The metadata for a 3D model (model_meta) describes the 3D model of a 3D object. The 3D model can be any technically feasible 3D structure or mathematical model representing the 3D object, such as a mesh, a point cloud, a wireframe model, or a manifold. In some embodiments, the 3D model 110 includes a polygonal mesh composed of interconnected triangles (triangular mesh). A 3D model can represent a real-world object or can represent a virtual object, such as a video game character. The texture metadata (texture_meta) for a 3D object describes the texture of a 3D object. The texture of the 3D object can comprise a set of images that define the appearance (such as color and surface properties) of the 3D object that wraps around (overlays) a mesh of the 3D object. For instance, a mesh of a head object can have textures for the eyes, eyebrows, hair, and some shadows to distinguish features such as the nose and the mouth of the head object.

The color scheme of a 3D object comprises one or more colors specified for the 3D object, whereby a 3D object typically comprises different colors associated with different portions of the 3D object. The color scheme metadata (colorsch_meta) for a 3D object specifies one or more of the most prominent/salient colors for the 3D object, such as the nine most prominent/salient colors. The animation of a 3D object represents the manner (dynamic movement characteristics) in which the 3D object performs particular actions, such as the manner in which the 3D object walks, jumps, or swings a sword. An animation can provide a set of basic animation cycles, where each set can be considered a self-contained animation, such as swinging a sword. The animation metadata (anim_meta) for a 3D object can describe a data structure with skeleton points across several time points. The motion of a 3D object comprises a predetermined path of motion of the 3D object, such as a predetermined path that the 3D object walks. The motion metadata (motion_meta) for a 3D object specifies the path of motion and the speed of motion (such as the speed of walking). The set of physical parameters of a 3D object can comprise material parameters and object parameters specified for the 3D object. The set of physical metadata (physical_meta) for a 3D object can specify physical parameters including friction, bounce, mass, drag, flotation, material type (such as wood, ceramic, metal, etc.), mass, friction, drag, bounce, and the like. The object properties for a 3D object can further include a 3D location associated with the 3D object. Metadata for the 3D location specifies 3D coordinates (such as x, y, z coordinates) indicating a placement location of the 3D object within the corresponding immersive environment 130. In other embodiments, object properties for a 3D object can further include model pieces (such as chair parts, or the fox model being separate from the sword model).

When a particular immersive environment 130 is selected by a user, the IE engine 110 (as stored in the memory unit 104 and executed by the processor 102 of FIG. 1) identifies the selected immersive environment 130 in the IE database 180 via the unique IE identifier 210 and retrieves the metadata for each virtual 3D object associated with the selected immersive environment 130 from the associated objects field 220. The IE engine 110 can then render and display each associated 3D object within the selected immersive environment 130 using the retrieved metadata. In particular, for each associated 3D object, the IE engine 110 can render the 3D object using the metadata for the 3D model, texture, color scheme, animation, motion, and physical parameters. Each associated 3D object 220 can be rendered and displayed at a location within the selected immersive environment 130 as specified by the 3D location metadata associated with the 3D object. During a sampling stage described below, a user selects a particular sampling immersive environment 132 stored in the IE database 180 from which to sample 3D digital components. During a remix stage described below, a user selects a particular remix immersive environment 134 stored in the IE database 180 from which to reuse/apply samples.

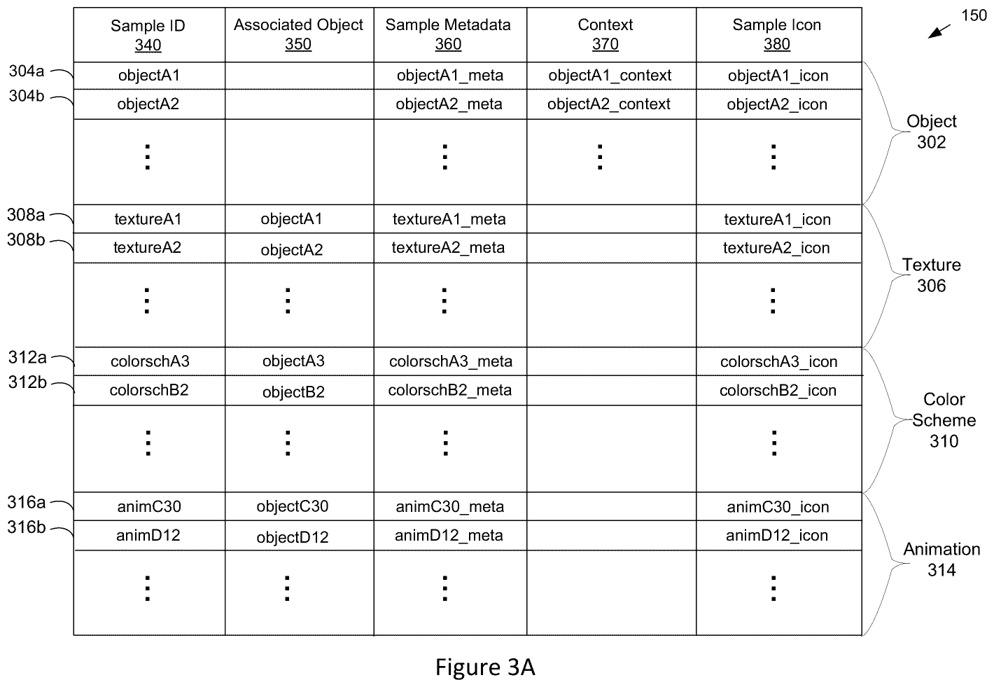

FIGS. 3A-3B are conceptual diagrams of the SPDS 150 of FIG. 1, according to various embodiments. The SPDS 150 provides the underlying storage of collected samples that are accessed and viewed via the SRUIs 160, such as the SPUI 166. The SPDS 150 provides storage of collected samples that is separate and distinct from the IE database 180 used for storing various immersive environments 130 and the 3D objects associated with the immersive environments 130. The SPDS 150 comprises different types of entries representing different types of samples. The different types of entries can be grouped into different sections depending on the types of entries. As shown, the SPDS 150 is subdivided into a plurality of sections including, without limitation, an object section 302, a texture section 306, a color-scheme section 310, an animation section 314, a motion section 318, a physical-parameters section 322, a single-color section 326, and a color-palette section 330. Each section of the SPDS 150 can store a particular type of entry corresponding to a particular type of sample.

In this regard, the object section 302 comprises zero or more object entries 304 (such as 304a and 304b), each object entry 304 representing an entire object sample that was sampled/captured from within an immersive environment 130. The texture section 306 comprises zero or more texture entries 308 (such as 308a and 308b), each texture entry 308 representing a texture sample that was sampled/captured from within an immersive environment 130. The color-scheme section 310 comprises zero or more color-scheme entries 312 (such as 312a and 312b), each color-scheme entry 312 representing a color-scheme sample that was sampled/captured from within an immersive environment 130. The animation section 314 comprises zero or more animation entries 316 (such as 316a and 316b), each animation entry 316 representing an animation sample that was sampled/captured from within an immersive environment 130. The motion section 318 comprises zero or more motion entries 320 (such as 320a and 320b), each motion entry 320 representing a motion sample that was sampled/captured from within an immersive environment 130. The physical-parameters section 322 comprises zero or more physical-parameters entries 324 (such as 324a and 324b), each physical-parameters entry 324 representing a physical-parameters sample that was sampled/captured from within an immersive environment 130. The single-color section 326 comprises zero or more single-color entries 328 (such as 328a and 328b), each single-color entry 328 representing a single-color sample that was sampled/captured from within an immersive environment 130. The color-palette section 330 comprises zero or more color-palette entries 332 (such as 332a and 332b), each color-palette entry 332 representing a color-palette sample that was sampled/captured from within an immersive environment 130.

Each entry of the SPDS 150 corresponds to a particular sample and comprises a plurality of data fields associated with and describing the sample, such as data fields for a sample identifier 340, an associated object 350, sample metadata 360, context 370, and a sample icon 380. The sample identifier field 340 of an entry comprises a unique identifier that uniquely identifies the entry and the corresponding sample. In some embodiments, the identifier field 340 of an entry can also identify the type of corresponding sample, such as an object, texture, animation, and the like. The associated object field 350 specifies the 3D object from which the sample was derived or captured. The sample metadata field 360 of an entry comprises metadata that is captured for the sample. The sample metadata field 360 includes metadata that can be used to render an entire 3D object or render a specific property of a 3D object. The type of entry and corresponding sample determines the type of metadata stored in the sample metadata field 360. For example, a texture entry for a texture sample will store texture metadata in the sample metadata field 360. The context field 370 of an entry specifies context information for where the corresponding sample was captured. The sample icon field 380 of an entry comprises text and/or graphics data for rendering and displaying a 2D or 3D icon that visually represents (in a simplified manner) the corresponding sample. As discussed below, the data fields included in a particular entry of the SPDS 150 can vary depending on the type of the entry and the type of the corresponding sample.

An object entry 304 representing an object sample that captures metadata for an entire 3D object can include the identifier field 340, the sample metadata field 360, the context field 370, and the sample icon field 380. The identifier field 340 can correspond to the identifier for the 3D object in the IE database 180. In some embodiments, the identifier field 340 for an object entry 304 can also indicate an IE identifier for the particular immersive environment 130 from which the object sample was captured. The sample metadata field 360 comprises all metadata associated with the entire 3D object, including metadata describing a 3D model, texture, color scheme, animation, motion, and physical parameters of the 3D object. The context field 370 specifies where the 3D object was sampled and includes an IE identifier 210 of a particular immersive environment 130 from which the 3D object was sampled, the 3D location coordinates of the 3D object within the particular immersive environment 130 when the 3D object was sampled, and the 3D location coordinates of the user viewpoint within the particular immersive environment 130 when the 3D object was sampled. The sample icon field 380 can comprise text and/or graphics metadata for rendering a 2D or 3D object sample icon that visually represents (in a simplified manner) the object sample and the 3D object.

A texture entry 308 representing a texture sample that captures only a texture property of a 3D object (and not other properties of the 3D object) can include the sample identifier field 340, the associated object field 350, the sample metadata field 360, and the sample icon field 380. The identifier field 340 uniquely identifies the texture entry 308 and the texture sample and can further specify the sample type (texture). The associated object field 350 specifies the object identifier of the 3D object from which the texture sample was originally derived and captured. The sample metadata field 360 comprises the texture metadata of the 3D object. The sample icon field 380 can comprise text and/or graphics metadata for rendering a 2D or 3D texture sample icon that visually represents (in a simplified manner) the texture sample of the 3D object.

A color-scheme entry 312 representing a color-scheme sample that captures only a color-scheme property of a 3D object (and not other properties of the 3D object) can include the sample identifier field 340, the associated object field 350, the sample metadata field 360, and the sample icon field 380. The identifier field 340 uniquely identifies the color-scheme entry 312 and the color-scheme sample and can further specify the sample type (color-scheme). The associated object field 350 specifies the object identifier of the 3D object from which the color-scheme sample was originally derived and captured. The sample metadata field 360 comprises the color-scheme metadata of the 3D object. The sample icon field 380 can comprise text and/or graphics metadata for rendering a 2D or 3D color-scheme sample icon that visually represents (in a simplified manner) the color-scheme sample of the 3D object.

An animation entry 316 representing an animation sample that captures only an animation property of a 3D object (and not other properties of the 3D object) can include the sample identifier field 340, the associated object field 350, the sample metadata field 360, and the sample icon field 380. The identifier field 340 uniquely identifies the animation entry 316 and the animation sample and can further specify the sample type (animation). The associated object field 350 specifies the object identifier of the 3D object from which the animation sample was originally derived and captured. The sample metadata field 360 comprises the animation metadata of the 3D object. The sample icon field 380 can comprise text and/or graphics metadata for rendering a 2D or 3D animation sample icon that visually represents (in a simplified manner) the animation sample of the 3D object.

A motion entry 320 representing a motion sample that captures only a motion property of a 3D object (and not other properties of the 3D object) can include the sample identifier field 340, the associated object field 350, the sample metadata field 360, and the sample icon field 380. The identifier field 340 uniquely identifies the motion entry 320 and the motion sample and can further specify the sample type (motion). The associated object field 350 specifies the object identifier of the 3D object from which the motion sample was originally derived and captured. The sample metadata field 360 comprises the motion metadata of the 3D object. The sample icon field 380 can comprise text and/or graphics metadata for rendering a 2D or 3D motion sample icon that visually represents (in a simplified manner) the motion sample of the 3D object.

A physical-parameters entry 324 representing a physical-parameters sample that captures only the physical-parameters property of a 3D object (and not other properties of the 3D object) can include the sample identifier field 340, the associated object field 350, the sample metadata field 360, and the sample icon field 380. The identifier field 340 uniquely identifies the physical-parameters entry 324 and the physical-parameters sample and can further specify the sample type (physical-parameters). The associated object field 350 specifies the object identifier of the 3D object from which the physical-parameters sample was originally derived and captured. The sample metadata field 360 comprises the physical-parameters metadata of the 3D object. The sample icon field 380 can comprise text and/or graphics metadata for rendering a 2D or 3D physical-parameters sample icon that visually represents (in a simplified manner) the physical-parameters sample of the 3D object.

Object-based samples include the above-described entire object sample of a 3D object and object property samples of properties of a 3D object (texture, color scheme, animation, motion, and physical parameters of the 3D object). Note that each object property sample of a 3D object is separate and distinct from the object sample of the 3D object. Likewise, each object property entry for an object property sample of a 3D object is separate and distinct from the object entry for the object sample of the 3D object. As such, each object property sample of a 3D object can be accessed, viewed, and reused/applied separately and independently from the object sample of the 3D object. In addition, the user could desire to capture only particular object property samples of a 3D object, without capturing an entire object sample of the 3D object. For example, the user can select to capture only a texture sample and an animation sample of a 3D object, without capturing other object property samples or an object sample of the entire 3D object. In this manner, the described techniques provide the user full control over which 3D digital components to sample from within an immersive environment 130.

A single-color entry 328 representing a single-color sample that captures a single-color associated with a specific point in an immersive environment 130 can include the sample identifier field 340, the sample metadata field 360, and the sample icon field 380. The sample identifier field 340 uniquely identifies the single-color entry 328 and the single-color sample and can further specify the sample type (single-color). The sample metadata field 360 comprises metadata that describes the captured single color. The sample icon field 380 can comprise text and/or graphics metadata for rendering a 2D or 3D single-color sample icon that visually represents (in a simplified manner) the single-color sample.

A color-palette entry 332 representing a color-palette sample that captures multiple colors associated with multiple 3D objects can include the sample identifier field 340, the sample metadata field 360, and the sample icon field 380. The sample identifier field 340 uniquely identifies the color-palette entry 332 and the color-palette sample and can further specify the sample type (color-palette). The sample metadata field 360 comprises metadata that describes the captured multiple colors. The sample icon field 380 can comprise text and/or graphics metadata for rendering a 2D or 3D color-palette sample icon that visually represents (in a simplified manner) the color-palette sample.

### Sampling within an Immersive Environment

During a sampling stage, the user selects a particular immersive environment stored in the IE database 180 from which to sample 3D digital components, referred to herein as the sampling immersive environment 132. When the sampling immersive environment 132 is selected by the user, the IE engine 110 (as stored in the memory unit 104 and executed by the processor 102 of FIG. 1) identifies the sampling immersive environment 132 in the IE database 180 via the IE identifier 210 and retrieves the metadata for associated virtual 3D objects from the associated objects field 220. The IE engine 110 then renders and displays each 3D object associated with the sampling immersive environment 132 using the retrieved metadata on the IE headset 172. In addition, during a sampling stage, the SR engine 140 (as stored in the memory unit 104 and executed by the processor 102 of FIG. 1) generates and displays various sampling/remix user interfaces (SRUIs) 160 on the IE headset 172 to enable the sampling and reuse of the 3D digital components. The user interacts with the various SRUIs 160 using the IE controllers 176 to select particular 3D digital components to sample from the sampling immersive environment 132. In some embodiments, specific SRUIs 160 that are commonly used can be mapped to particular buttons on the IE controllers 176 to allow the user to easily access commonly used SRUIs 160, such as the SPUI 166.

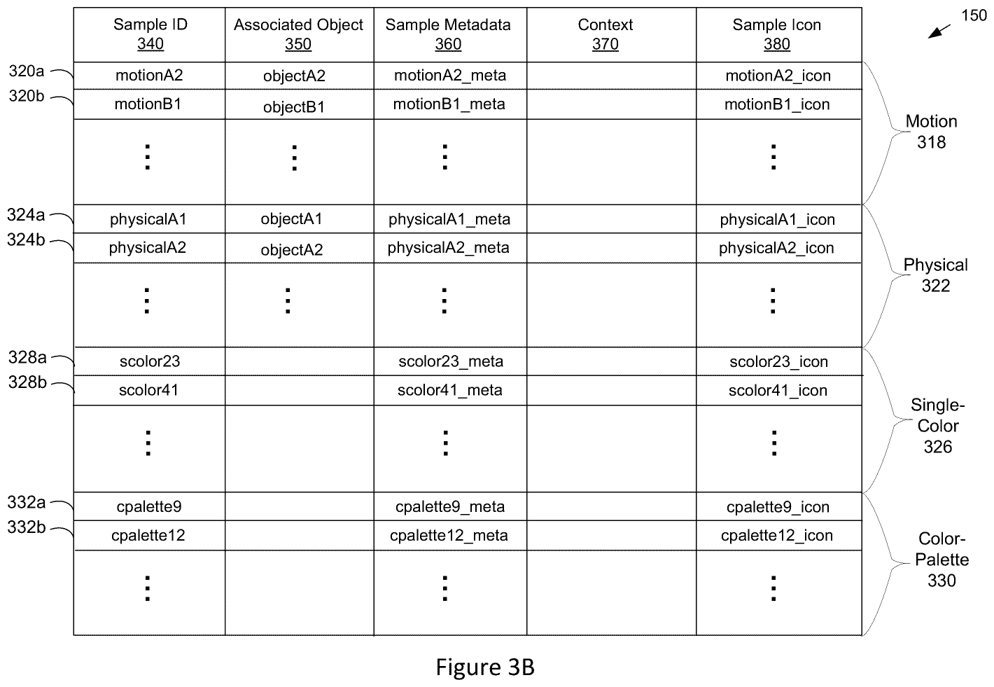

FIG. 4 is a screenshot of the sampling immersive environment 132 of FIG. 1, according to various embodiments. As shown, the sampling immersive environment 132 comprises a simulated 3D medieval village comprising a plurality of 3D objects, including a fox character, wood bucket, buildings, trees, plants, sky, ground, etc. The example of FIG. 4 shows a current IE scene 174 comprising a sub-portion of the sampling immersive environment 132 that is currently displayed in the IE headset 172. The user can control a user viewpoint within the sampling immersive environment 132 via the IE controllers 176 to explore and navigate the sampling immersive environment 132. The user can also control a cursor ray displayed in the IE scene 174 via the IE controllers 176 to interact with SRUIs 160 and select particular 3D objects within the sampling immersive environment 132.

In addition, the SR engine 140 (as stored in the memory unit 104 and executed by the processor 102 of FIG. 1) generates and displays a mode UI 400 in the IE scene 174. The mode UI 400 displays three selectable mode options including a sampling mode 410, a sample palette mode 420, and a remix mode 430. Selecting the sampling mode 410 initiates the sampling stage and enables the user to sample various 3D digital components within the sampling immersive environment 132 via the SRUIs 160. Selecting the sample palette mode 420 causes the SR engine 140 to generate and display the sample-palette user interface (SPUI) 166 which allows the user to view, access, and reuse/apply samples currently stored to the SPDS 150. Selecting the remix mode 430 initiates the remix stage and enables the user to reuse/apply current samples within a remix immersive environment 134. In some embodiments, to allow easy access to the mode UI 400, the mode UI 400 can be mapped to a particular button on the IE controllers 176 or is continually displayed in a portion of the IE scene 174.

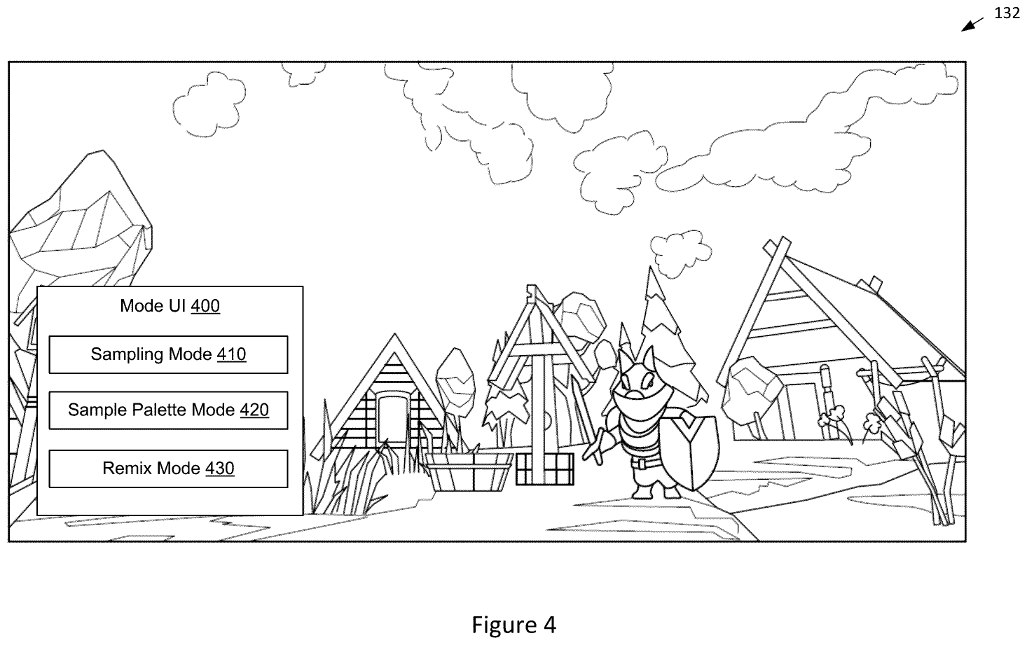

FIG. 5 is a screenshot of a sampling UI for a fox object displayed in the sampling immersive environment 132 of FIG. 1, according to various embodiments. In the example of FIG. 5, the user has selected the sampling mode 410 which causes the SR engine 140 to generate and display a sampling UI 500. The sampling UI 500 displays selectable options including a segmentation operation 510, an entire object sample 520, a texture sample 530, a color-scheme sample 540, an animation sample 550, a motion sample 560, a physical-parameters sample 570, a single-color sample 580, and a color-palette sample 590.

In some embodiments, object-based sampling (an object sample 520, a texture sample 530, a color-scheme sample 540, an animation sample 550, a motion sample 560, a physical-parameters sample 570) can be initiated by selecting a particular 3D object within the IE scene 174. In response, the SR engine 140 retrieves all object metadata (object_meta) associated with the selected 3D object from the IE database 180 using the IE identifier 210 for the particular sampling immersive environment 132 and the object identifier. The object metadata (object_meta) comprises the 3D model metadata (model_meta), texture metadata (texture_meta), color-scheme metadata (colorsch_meta), animation metadata (anim_meta), motion metadata (motion_meta), and the physical parameters metadata (physical_meta). The SR engine 140 then parses the object metadata (object_meta) into the different types of metadata (texture_meta, colorsch_meta, anim_meta, motion_meta, and physical_meta) for the different types of object properties to determine which types of metadata and object properties are available for sampling for the selected 3D object. In general, not all 3D objects include all the different types of metadata for all the different types of object properties. For example, a tree object or building object typically do not include animation metadata (anim_meta) and motion metadata (motion_meta) for the animation and motion properties. The SR engine 140 can then highlight (or indicates in another visual manner) the types of samples in the sampling UI 500 that can be captured based on the types of metadata and properties available for the selected 3D object.

As shown in the example of FIG. 5, the user has selected the fox object 594 within the sampling immersive environment 132. In response, the SR engine 140 retrieves all object metadata (object_meta) associated with the selected fox object 594 from the IE database 180 and parses the object metadata into the different types of metadata for the different types of object properties associated with the selected fox object 594. The SR engine 140 determines that the object metadata for the fox object 594 includes all the different types of metadata (texture_meta, colorsch_meta, anim_meta, motion_meta, and physical_meta) for all the different types of object properties. The SR engine 140 then highlights (or indicates in another visual manner) the types of sampling options in the sampling UI 500 that can be captured for the selected fox object 594, including the entire object sample 520, the texture sample 530, the color-scheme sample 540, the animation sample 550, the motion sample 560, and the physical-parameters sample 570.

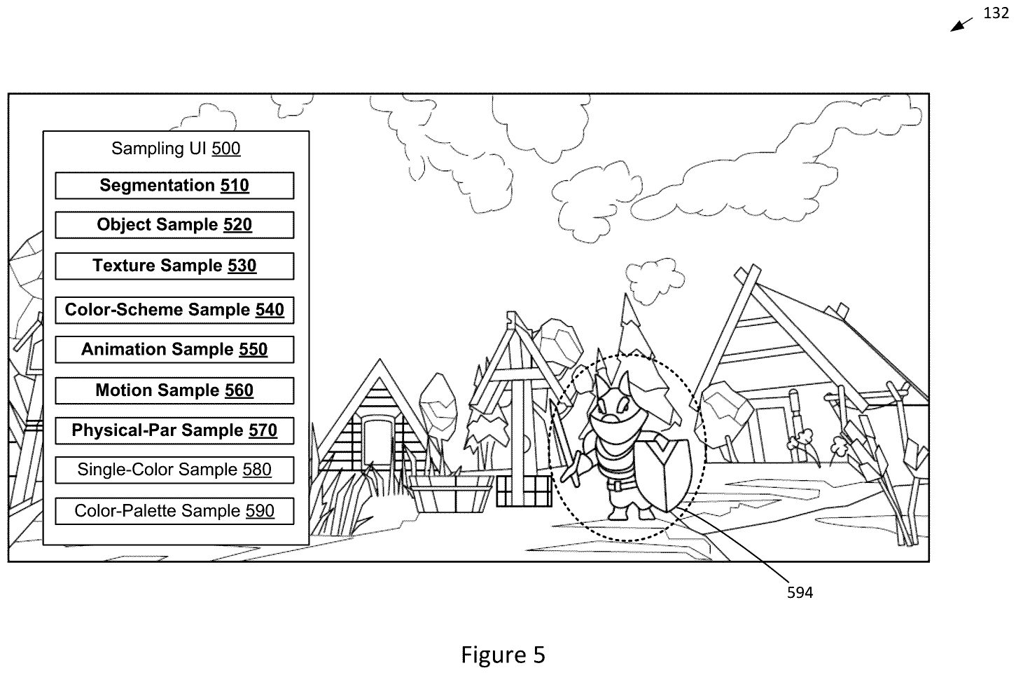

FIG. 6 is a screenshot of a sampling UI for a chair object displayed in the sampling immersive environment 132 of FIG. 1, according to various embodiments. In the example of FIG. 6, the user has selected the chair object 694. In response, the SR engine 140 (as stored in the memory unit 104 and executed by the processor 102 of FIG. 1) retrieves all object metadata (object_meta) associated with the selected chair object 694 from the IE database 180 and parses the object metadata into the different types of metadata for the different types of object properties available for the selected chair object 694. The SR engine 140 determines that the object metadata for the chair object 694 includes all the different types of metadata except for the animation and motion object properties. The SR engine 140 then highlights (or indicates in another visual manner) the types of sampling options in the sampling UI 500 that can be captured for the selected chair object 694, including the entire object sample 520, the texture sample 530, the color-scheme sample 540, and the physical-parameters sample 570. Note that the sampling UI 500 does not highlight the object-based sampling options (animation sample 550 and motion sample 560) that are not available for the selected chair object 694. In other embodiments, the SR engine 140 can remove the unavailable sampling options (such as the animation sample 550 and motion sample 560) from the sampling UI 500.

Referring back to FIG. 5, the user can then select among the object-based samples available for the selected fox object 594. As indicated in the sampling UI 500, the available samples include the entire object sample 520, the texture sample 530, the color-scheme sample 540, the animation sample 550, the motion sample 560, and the physical-parameters sample 570.

If the user selects the object sample 520, in response, the SR engine 140 captures/samples object metadata for the entire fox object 594 by generating a new object entry 304 representing a new object sample in the object section 302 of the SPDS 150. The SR engine 140 then fills in the various data fields for the new object entry 304, including the sample identifier field 340, the sample metadata field 360, the context field 370, and the sample icon field 380. In particular, the SR engine 140 stores all the object metadata (object_meta) retrieved for the fox object 594 to the sample metadata field 360, including the 3D model metadata (model_meta), texture metadata (texture_meta), color-scheme metadata (colorsch_meta), animation metadata (anim_meta), motion metadata (motion_meta), and the physical parameters metadata (physical_meta). The SR engine 140 can also generate text and/or graphics metadata for rendering a 2D or 3D object icon that visually represents (in a simplified manner) the new object sample and the fox object 594 based on the object metadata (object_meta). The text and/or graphics metadata is then stored to the sample icon field 380 in the new object entry 304.

For object samples, the SR engine 140 fills in the context field 370 in the new object entry 304, for example, by interacting with the IE engine 110 to determine context information for the selected fox object 594, including the IE identifier 210 for the sampling immersive environment 132 from which the fox object 594 is sampled, the 3D location coordinates of the fox object 594 within the sampling immersive environment 132 when the fox object 594 is sampled (which can be determined by the current 3D location coordinates of the fox object 594 as displayed within the current IE scene 174), and the 3D location coordinates of the user viewpoint within the sampling immersive environment 132 when the fox object 594 is sampled (which can be determined by the current 3D location coordinates of the user viewpoint as displayed within the current IE scene 174). In some embodiments, the above context information is stored to the context field 370 in the form of a reference pointer or link to the 3D location in the particular sampling immersive environment 132 from where the fox object 594 was sampled.

If the user selects the texture sample 530, in response, the SR engine 140 captures/samples the texture metadata for the fox object 594 by generating a new texture entry 308 representing a new texture sample in the texture section 306 of the SPDS 150. The SR engine 140 then fills in the various data fields of the new texture entry 308, including the sample identifier field 340, the associated object field 350, the sample metadata field 360, and the sample icon field 380. In particular, the SR engine 140 stores the texture metadata (texture_meta) retrieved and parsed out for the fox object 594 to the sample metadata field 360. The associated object field 350 specifies the object identifier for the fox object 594 from which the new texture sample is derived or captured, which can be retrieved from the IE database 180. The SR engine 140 also generates text and/or graphics metadata for rendering a 2D or 3D texture icon that visually represents (in a simplified manner) the new texture sample based on the texture metadata (texture_meta). The text and/or graphics metadata is then stored to the sample icon field 380 in the new texture entry 308.

If the user selects the color-scheme sample 540, in response, the SR engine 140 captures/samples the color-scheme metadata for the fox object 594 by generating a new color-scheme entry 312 representing a new color-scheme sample in the color-scheme section 310 of the SPDS 150. The SR engine 140 then fills in the various data fields of the new color-scheme entry 312, including the sample identifier field 340, the associated object field 350, the sample metadata field 360, and the sample icon field 380. In particular, the SR engine 140 stores the color-scheme metadata (colorsch_meta) retrieved and parsed out for the fox object 594 to the sample metadata field 360. The associated object field 350 specifies the object identifier for the fox object 594 from which the new color-scheme sample is derived or captured, which can be retrieved from the IE database 180. The SR engine 140 also generates text and/or graphics metadata for rendering a 2D or 3D color-scheme icon that visually represents (in a simplified manner) the new color-scheme sample based on the color-scheme metadata (colorsch_meta). The text and/or graphics metadata is then stored to the sample icon field 380 in the new color-scheme entry 312.

If the user selects the animation sample 550, in response, the SR engine 140 captures/samples the animation metadata for the fox object 594 by generating a new animation entry 316 representing a new animation sample in the animation section 314 of the SPDS 150. The SR engine 140 then fills in the various data fields of the new animation entry 316, including the sample identifier field 340, the associated object field 350, the sample metadata field 360, and the sample icon field 380. In particular, the SR engine 140 stores the animation metadata (anim_meta) retrieved and parsed out for the fox object 594 to the sample metadata field 360. The associated object field 350 specifies the object identifier for the fox object 594 from which the new animation sample is derived or captured, which can be retrieved from the IE database 180. The SR engine 140 also generates text and/or graphics metadata for rendering a 2D or 3D animation icon that visually represents (in a simplified manner) the new animation sample based on the animation metadata (anim_meta). For example, the animation icon can display an in-place neutral mannequin to represent an avatar animation. The text and/or graphics metadata is then stored to the sample icon field 380 in the new animation entry 316.

If the user selects the motion sample 560, in response, the SR engine 140 captures/samples the motion metadata for the fox object 594 by generating a new motion entry 320 representing a new motion sample in the motion section 318 of the SPDS 150. The SR engine 140 then fills in the various data fields of the new motion entry 320, including the sample identifier field 340, the associated object field 350, the sample metadata field 360, and the sample icon field 380. In particular, the SR engine 140 stores the motion metadata (motion_meta) retrieved and parsed out for the fox object 594 to the sample metadata field 360. The associated object field 350 specifies the object identifier for the fox object 594 from which the new motion sample is derived or captured, which can be retrieved from the IE database 180. The SR engine 140 also generates text and/or graphics metadata for rendering a 2D or 3D motion icon that visually represents (in a simplified manner) the new motion sample based on the motion metadata (motion_meta). For example, the motion icon can display an outline of a walking path. The text and/or graphics metadata is then stored to the sample icon field 380 in the new motion entry 320.

If the user selects the physical-parameters sample 570, in response, the SR engine 140 captures/samples the physical-parameters metadata for the fox object 594 by generating a new physical-parameters entry 324 representing a new physical-parameters sample in the physical-parameters section 322 of the SPDS 150. The SR engine 140 then fills in the various data fields of the new physical-parameters entry 324, including the sample identifier field 340, the associated object field 350, the sample metadata field 360, and the sample icon field 380. In particular, the SR engine 140 stores the physical-parameters metadata (physical_meta) retrieved and parsed out for the fox object 594 to the sample metadata field 360. The associated object field 350 specifies the object identifier for the fox object 594 from which the new physical-parameters sample is derived or captured, which can be retrieved from the IE database 180. The SR engine 140 also generates text and/or graphics metadata for rendering a 2D or 3D physical-parameters icon that visually represents (in a simplified manner) the new physical-parameters sample based on the physical-parameters metadata (physical_meta). The text and/or graphics metadata is then stored to the sample icon field 380 in the new physical-parameters entry 324.

Note that each new object property sample (texture sample, color scheme sample, animation sample, motion sample, and physical parameters sample) of the fox object 594 is separate and distinct from the object sample of the fox object 594. Likewise, each new object property entry for the corresponding new object property sample is separate and distinct from the object entry for the object sample of the fox object 594. As such, each object property sample of the fox object 594 can be accessed, viewed, and applied separately and independently from the object sample of the fox object 594.

In some embodiments, the SR engine 140 also enables segmentation functionality to segment/deconstruct a selected 3D object into two or more sub-parts. If the user selects a particular 3D object in the sampling immersive environment 132 and selects the segmentation operation 510 from the sampling UI 500, the SR engine 140 executes a deconstructing algorithm/tool to separate the selected 3D object into two or more sub-parts. The sub-parts of a 3D object are pre-defined in the metadata, whereby the deconstructing algorithm/tool identifies these sub-parts via the metadata and displays the separate sub-parts.

The SR engine 140 then adds each sub-part of the selected 3D object as a separate and independent 3D object associated with the sampling immersive environment 132 in the IE entry 230 representing the sampling immersive environment 132 in the IE database 180. Each sub-part of the selected 3D object is then selectable as a 3D object in the same manner as any other 3D object within the sampling immersive environment 132. The above-described object-based sampling operations can then be performed on a selected sub-part of the selected 3D object in the same manner as any other 3D object within the sampling immersive environment 132.

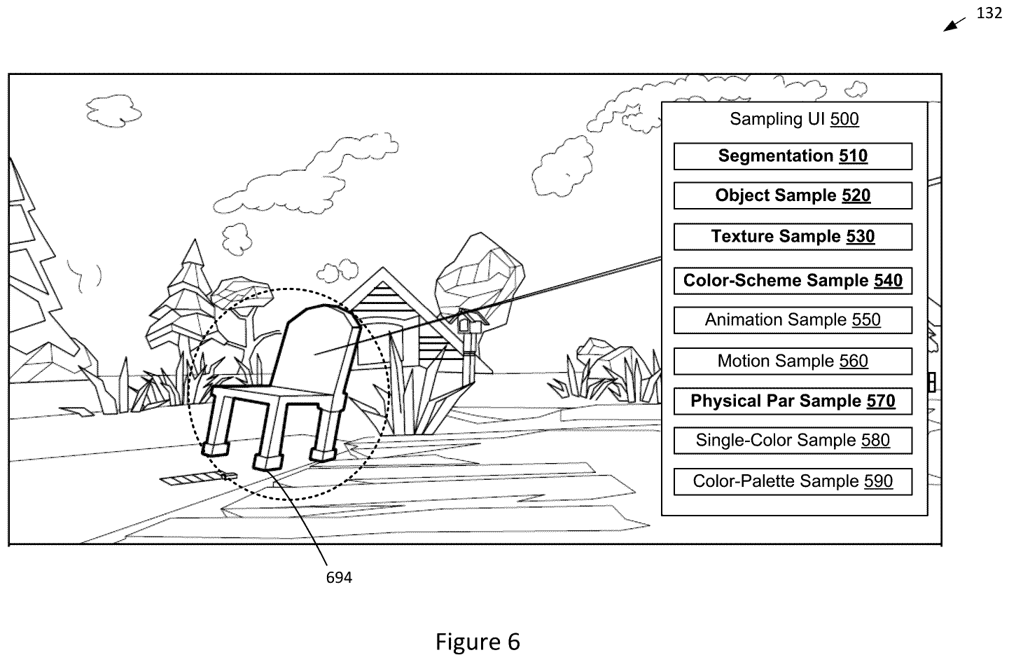

FIGS. 7A-7B are screenshots of a segmentation operation for a chair object displayed in the sampling immersive environment 132 of FIG. 1, according to various embodiments. In the example of FIG. 7A, the user has selected the chair object 794 and selected the segmentation operation 510 from the sampling UI 500. In response, the SR engine 140 executes a deconstructing algorithm/tool to separate/deconstruct the selected chair object 794 into a plurality of sub-parts 710, as shown in FIG. 7B. The SR engine 140 then adds each sub-part of the chair object 794 as a separate and independent 3D object associated with the sampling immersive environment 132 in the IE entry 230 representing the sampling immersive environment 132 in the IE database 180. Each sub-part of the plurality of sub-parts 710 can then be separately selectable as an independent chair sub-part object for sampling purposes.

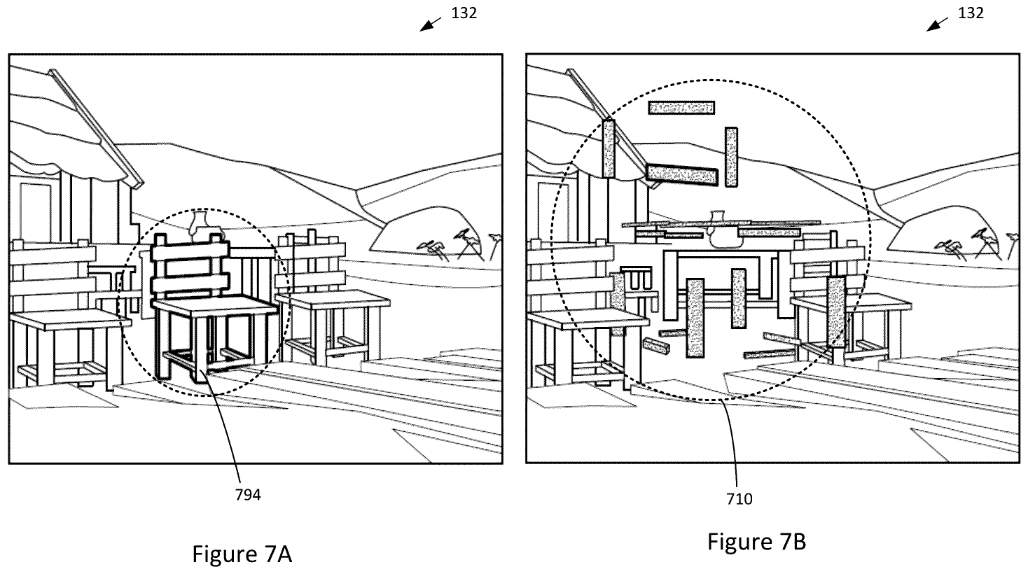

To capture a color-based sample, the user can select the single-color sample 580 or the color-palette sample 590 from the sampling UI 500. If the user selects the single-color sample 580, in response the SR engine 140 generates and displays a single-color UI to enable the user to capture a single-color sample of a specific point/location within the sampling immersive environment 132. FIG. 8 is a screenshot of a single-color UI 800 displayed in the sampling immersive environment 132 of FIG. 1, according to various embodiments. The single-color UI 800 displays a selectable “Take Sample” button 810 and a single-color suggestion window 820. The user then selects a specific point/location within the sampling immersive environment 132 via the cursor ray that is controlled using the IE controllers 176.

In the example of FIG. 8, the user selects a point/location on a wooden bucket object 894. Once the sample point/location is selected, the user selects the “Take Sample” button 810. In response, the SR engine 140 captures/samples a single-color sample by generating a new single-color entry 328 representing a new single-color sample in the single-color section 326 of the SPDS 150. The SR engine 140 then fills in the various data fields of the new single-color entry 328, including the sample identifier field 340, the sample metadata field 360, and the sample icon field 380. In particular, the SR engine 140 stores the single-color metadata (scolor_meta) determined for the selected sample point to the sample metadata field 360. The SR engine 140 also generates text and/or graphics metadata for rendering a 2D or 3D icon that visually represents the new single-color sample based on the single-color metadata (scolor_meta). The text and/or graphics metadata is then stored to the sample icon field 380 in the new single-color entry 328.

The single-color metadata (scolor_meta) can be determined using various techniques. In some embodiments, the SR engine 140 implements a point sample technique that casts a ray from a virtual IE controller 176 displayed in the IE scene 174 to the selected sample point. The casted ray will intersect an object that contains the selected sample point. The SR engine 140 can then access a color/texture coordinate of the object at the ray intersection point, retrieve color metadata of the object associated with the color/texture coordinate, and interpolate a most prominent/salient color based on retrieved color metadata. The SR engine 140 then generates the single-color metadata (scolor_meta) based on the returned most prominent/salient color. In other embodiments, the SR engine 140 implements a region sample technique by capturing an image of a predetermined region around the selected sample point, quantizing/sampling the image to determine, for example, the five most dominant/common color clusters, and return a single most dominant/common cluster. The SR engine 140 then generates the single-color metadata (scolor_meta) based on the returned most dominant/common cluster. In contrast to the point sample technique, the region sample technique can factor in the effect of lighting on the colors. In further embodiments, the SR engine 140 implements another type of technique to determine the single-color metadata (scolor_meta).

In addition, the SR engine 140 can provide further suggestions for single-color samples based on the current single-color sample via the single-color suggestion window 820. The single-color suggestion window 820 can include a plurality of suggested images 830 (such as 830a, 830b, 830c, etc.) for additional single-color sampling. In particular, the SR engine 140 can initiate or execute an image search on an image server (such as server 190) that stores collections of stock images/photos. For example, the search can be performed to identify stock images having colors that are similar to the current single-color sample. For each identified image, the SR engine 140 can then retrieve the image from the image server 190, store the image as a sampling suggestion 152 within the memory unit 104, and display the image in the single-color suggestion window 820 as a suggested image 830. If the user then desires to sample a suggested image 830, the user can select a specific point/location within a suggested image 830 and select the “Take Sample” button 810. In response, the SR engine 140 captures/samples a single-color component associated with the sample point/location in the suggested image 830 by generating a new single-color entry 328 representing a new single-color sample in the single-color section 326 of the SPDS 150.

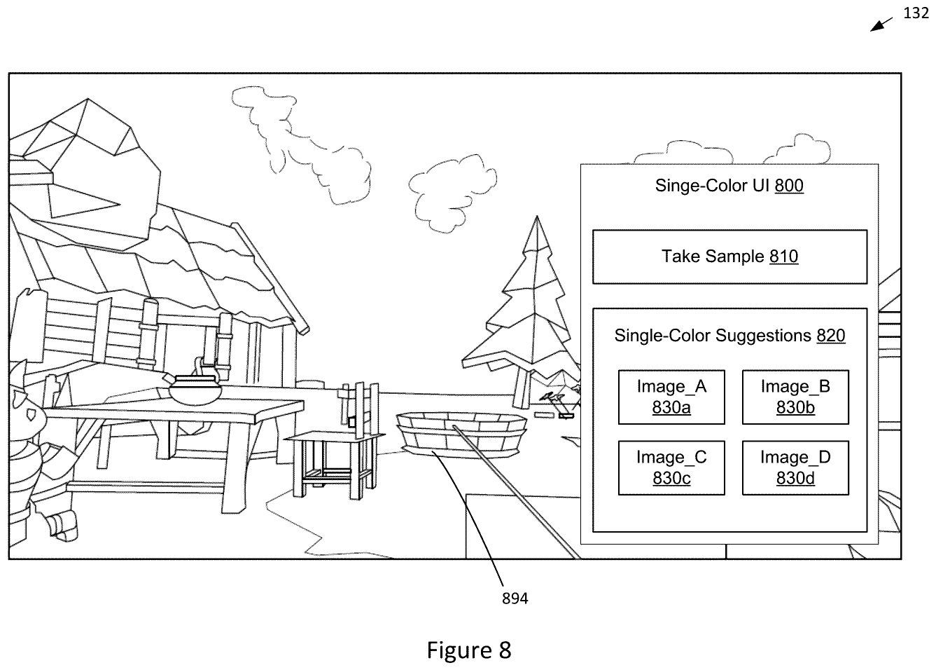

If the user selects the color-palette sample 590 from the sampling UI 500, in response the SR engine 140 generates and displays a color-palette UI to enable the user to capture a color-palette sample of multiple 3D objects within the sampling immersive environment 132. In general, a color-palette comprises a group of two or more colors associated with two or more objects. A color palette can capture a color scheme that is present across an IE scene, and capture more abstract aspects of the IE scene, such as tone, hue, saturation, brightness, contrast, lighting, mood, atmosphere, etc. FIG. 9 is a screenshot of a color-palette UI 900 displayed in the sampling immersive environment 132 of FIG. 1, according to various embodiments. The color-palette UI 900 displays a selectable “Global Selection” button 902, a selectable “Take Sample” button 910, and a color-palette suggestion window 920. The user then selects multiple 3D objects within the sampling immersive environment 132 via the cursor ray that is controlled using the IE controllers 176. Alternatively, the user can select the “Global Selection” button 902 to automatically select all 3D objects displayed within the current IE scene 174.

In the example of FIG. 9, the user selects a chair object 950, a bucket object 960, and a tree object 970. Once the 3D objects are selected, the user selects the “Take Sample” button 910. In response, the SR engine 140 captures a color-palette sample by generating a new color-palette entry 332 representing a new color-palette sample in the color-palette section 330 of the SPDS 150. The SR engine 140 then fills in the various data fields of the new color-palette entry 332, including the sample identifier field 340, the sample metadata field 360, and the sample icon field 380. In particular, the SR engine 140 stores the color-palette metadata (cpalette_meta) determined for the selected 3D objects to the sample metadata field 360. The SR engine 140 also generates text and/or graphics metadata for rendering a 2D or 3D icon that visually represents the new color-palette sample based on the color-palette metadata (cpalette_meta). The text and/or graphics metadata is then stored to the sample icon field 380 in the new color-palette entry 332.

The color-palette sample comprises two or more of the most prominent/salient colors associated with the multiple selected 3D objects. The color-palette metadata (cpalette_meta) can be determined using various techniques. In some embodiments, the SR engine 140 implements a region sample technique by capturing an image that includes the multiple selected 3D objects, quantizing/sampling the image to determine, for example, the five most dominant/common color clusters, and returning the five most dominant/common color clusters as the multiple colors that represent the multiple selected 3D objects. The SR engine 140 then generates the color-palette metadata (cpalette_meta) based on the returned five most dominant/common color clusters. In other embodiments, the SR engine 140 returns a different number of most dominant/common color clusters as the multiple colors that represent the multiple selected 3D objects. In other embodiments, the SR engine 140 implements another type of technique to determine the color-palette metadata (cpalette_meta).

In addition, the SR engine 140 can provide further suggestions for color-palette samples based on the current color-palette sample via the color-palette suggestion window 920. The color-palette suggestion window 920 can include a plurality of suggested images 930 (such as 930a, 930b, 930c, etc.) for additional color-palette sampling. In particular, the SR engine 140 can initiate or execute an image search on an image server (such as server 190) that stores collections of stock images/photos. For example, the search can be performed to identify stock images having multiple colors that are similar to the current color-palette sample. For each identified image, the SR engine 140 can then retrieve the image from the image server 190, store the image as a sampling suggestion 152 within the memory unit 104, and display the image in the color-palette suggestion window 920 as a suggested image 930. If the user then desires to sample a particular suggested image 930, the user can select the particular suggested image 930 and select the “Take Sample” button 910. In response, the SR engine 140 captures/samples a color-palette component associated with the suggested image 930 by generating a new color-palette entry 332 representing a new color-palette sample in the color-palette section 330 of the SPDS 150.

In some embodiments, the SR engine 140 also provides system-initiated suggestions for additional object-based sampling of 3D digital components within the current IE scene 174 of the sampling immersive environment 132. The SR engine 140 can generate and display various suggestion pop-up windows within the sampling immersive environment 132 containing various suggestions for further samples based on the current samples being taken and/or the user interactions with particular 3D objects within the sampling immersive environment 132. For example, the SR engine 140 can generate suggestions for further samples based on a currently selected 3D object.

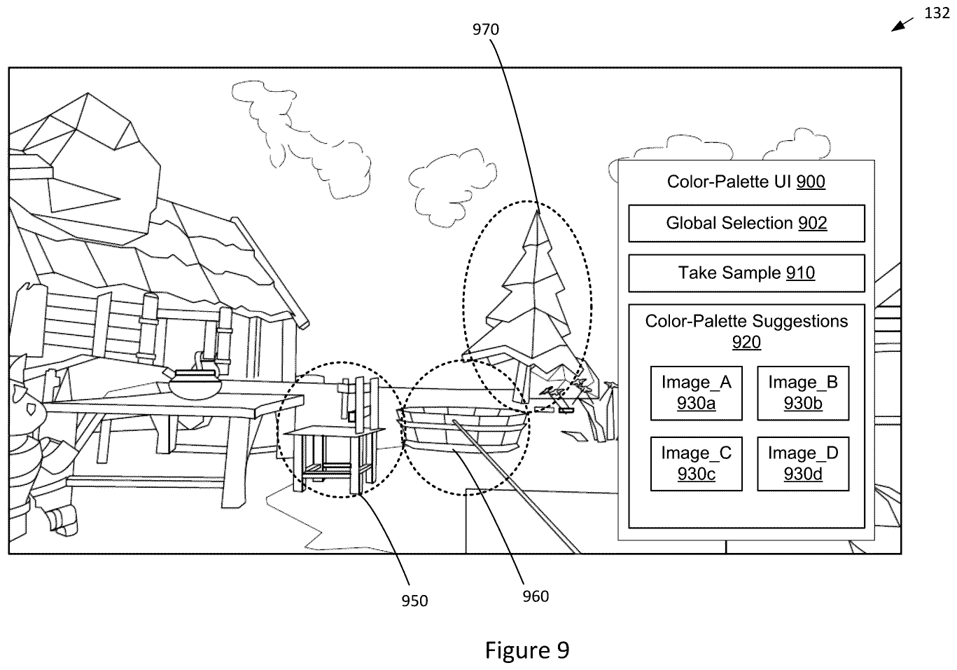

FIG. 10 is a screenshot of suggestion windows 1010 and 1020 displayed in the sampling immersive environment 132 of FIG. 1, according to various embodiments. As shown, a first suggestion window 1010 displays suggestions for sampling additional 3D objects, textures, and color schemes by displaying visualization icons for the 3D objects, textures, and color schemes. In other embodiments, the first suggestion window 1010 also displays suggestions for sampling additional animations, motions, and physical parameters (not shown). In the example of FIG. 10, the user has selected the fox object, and in response, the SR engine 140 generates the sampling suggestions in the first suggestion window 1010 based on the selected fox object.

For example, the SR engine 140 can initiate or execute a text-based search in the IE database 180 for object identifiers based on the search word “fox” to identify the 3D objects that are most relevant to the selected fox object (such as the three most relevant 3D objects). For each identified 3D object, the SR engine 140 retrieves the entire object metadata for the 3D object, stores the object metadata for the 3D object as a sampling suggestion 152 within the memory unit 104, and also parses the object metadata into separate object property metadata for the different object properties of the 3D object, including metadata for texture, color scheme, animation, motion, and physical parameters. For each identified 3D object, the SR engine 140 can then generate an object icon for the 3D object and an object property icon for each of object property based on the retrieved metadata and displays the icons in the first suggestion window 1010. The user can then select a particular icon in the first suggestion window 1010 for sampling a 3D object or object property corresponding to the selected icon. In a manner similar to generating new samples of 3D objects or object properties of a 3D object described in relation to FIG. 5, a new sample entry representing a new object-based sample can be generated and stored in the SPDS 150 for capturing the new object-based sample. An object property sampled in this manner can also be associated with the currently selected 3D object (such as the fox object), as indicated in the associated object field 350 for the new sample entry.

In further embodiments, the SR engine 140 can also provide standard default sampling suggestions for particular object properties based on the currently selected 3D object (such as the fox object). The standard default sampling suggestions can be stored as sampling suggestions 152 within the memory unit 104. As shown, a second suggestion window 1020 displays suggestions for sampling standard default animations, motions, and physical parameters by displaying visualization icons for the standard default animations, motions, and physical parameters. In other embodiments, the second suggestion window 1020 also displays suggestions for sampling standard default textures and color schemes by displaying visualization icons for the standard default textures and color schemes (not shown). Note that if the currently selected 3D object is a non-moving object, such as a chair or bucket, the standard default animations and motions would not be suggested. The standard default animations and motions comprise animations and motions that are commonly applied to moveable characters, such as the fox object. The standard default physical parameters can comprise exaggerated/extreme physical parameters that characterize particular objects, such as an anvil (high mass), balloon (flotation, light), soccer ball (high bounciness), and ice block (low friction). The user can then select a particular icon in the second suggestion window 1020 for sampling a standard default object property corresponding to the selected icon. In a manner similar to generating new samples of object properties described in relation to FIG. 5, a new sample entry representing a new object-based sample can be generated and stored in the SPDS 150 for capturing the new object-based sample. A standard default object property sampled in this manner can also be associated with the currently selected 3D object (such as the fox object), as indicated in the associated object field 350 for the new sample entry.

### Sampling Palette User Interface

At any time during the sampling stage or the remix stage, the user can select the sample palette mode 420 from the mode UI 400 to view samples currently stored to the SPDS 150. In response to the user selection of the sample palette mode 420, the SR engine 140 generates and displays a sample-palette user interface (SPUI) 166 for viewing and accessing samples collected and organized in the SPDS 150. The SPUI 166 comprises a sample collection menu UI and a plurality of collection UIs, each collection UI corresponding to a different type of sample. The SPUI 166 can be displayed directly in the current immersive environment, such as the sampling immersive environment 132 or a remix immersive environment (discussed in detail below).

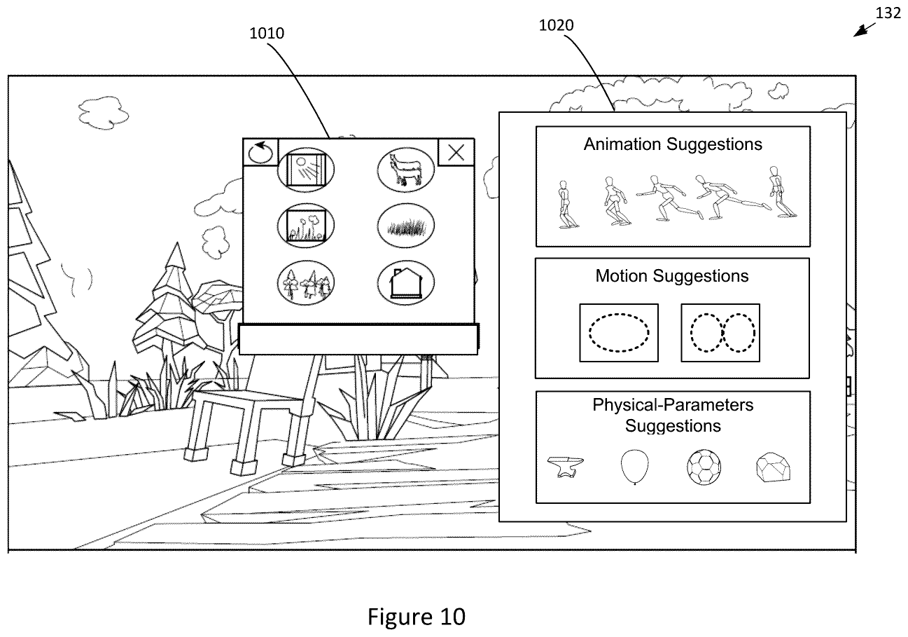

FIG. 11 illustrates a sample collection menu 1100 of the SPUI 166 of FIG. 1, according to various embodiments. As shown, the SPUI 166 initially displays a sample collection menu 1100 comprising an icon window 1110 and a plurality of selectable collections including an object collection 1120, a texture collection 1130, color-scheme collection 1140, animation collection 1150, motion collection 1160, physical-parameters collection 1170, and a single-color and color-palette collection 1180. The icon window 1110 is initially empty and is populated with sample icons once a sample collection is selected.

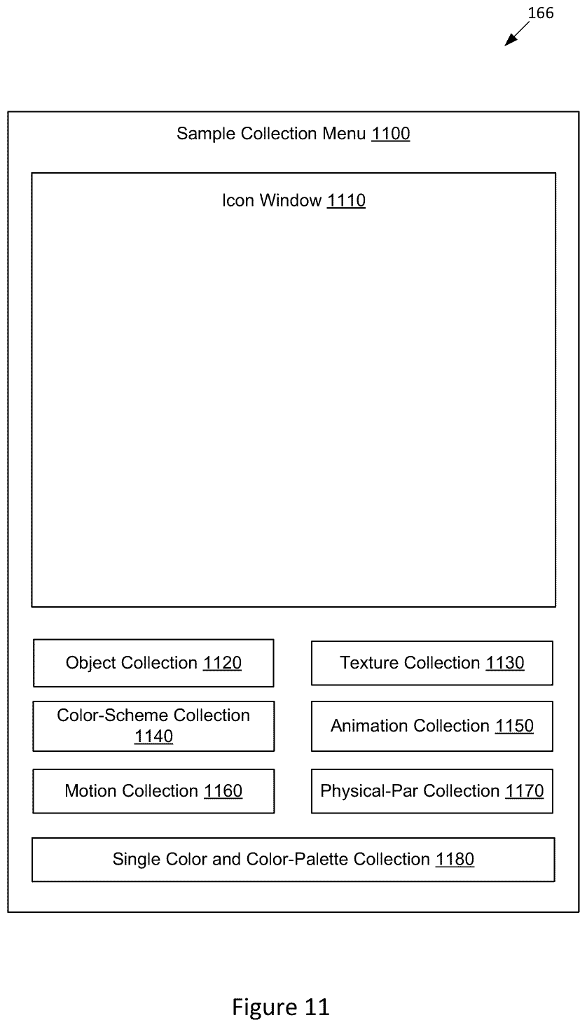

If the user selects the object collection 1120, the SR engine 140 generates and displays an object collection UI. FIG. 12 illustrates an object collection UI 1200 of the SPUI 166 of FIG. 1, according to various embodiments. As shown, the object collection UI 1200 continues to display the icon window 1110 and the plurality of selectable collections 1120-1180 displayed in the sample collection menu 1100. In addition, the SR engine 140 populates the icon window 1110 with zero or more object sample icons 1250 (such as 1250a, 1250b, 1250c, etc.) representing zero or more current object samples stored in the SPDS 150. In particular, the SR engine 140 can access the object section 302 in the SPDS 150 that stores zero or more object entries 304, each object entry 304 representing an object sample. For each object entry 304, the SR engine 140 can access the sample icon field 380 to retrieve the graphics metadata for rendering an object sample icon that visually represents the object sample. The SR engine 140 can then render the object sample icon based on the graphics metadata and display the object sample icon in the icon window 1110 for each object sample stored in the SPDS 150. The SR engine 140 can also display relevant text adjacent to each object sample icon, such as the object identifier and/or an IE identifier for the particular immersive environment 130 from which the object sample was captured (as specified in the sample identifier field 340).

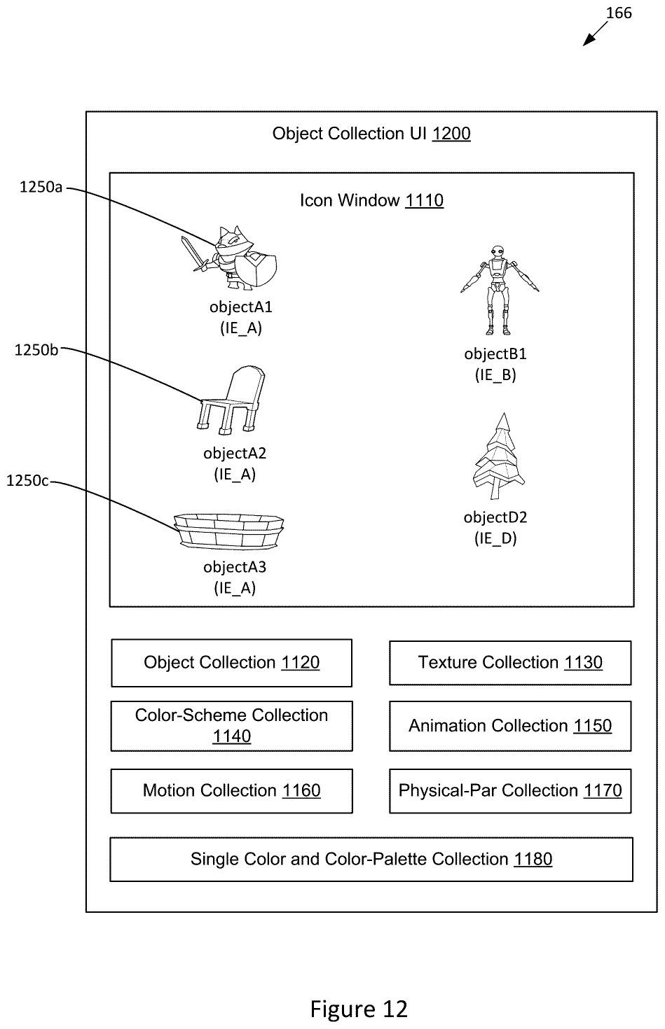

If the user selects the texture collection 1130, the SR engine 140 generates and displays a texture collection UI. FIG. 13 illustrates a texture collection UI 1300 of the SPUI 166 of FIG. 1, according to various embodiments. As shown, the texture collection UI 1300 continues to display the icon window 1110 and the plurality of selectable collections 1120-1180 displayed in the sample collection menu 1100. In addition, the SR engine 140 populates the icon window 1110 with zero or more texture sample icons 1350 (such as 1350a, 1350b, 1350c, etc.) representing zero or more current texture samples stored in the SPDS 150. In particular, the SR engine 140 can access the texture section 306 in the SPDS 150 that stores zero or more texture entries 308, each texture entry 308 representing a texture sample. For each texture entry 308, the SR engine 140 can access the sample icon field 380 to retrieve the graphics metadata for rendering a texture sample icon that visually represents the texture sample. The SR engine 140 can then render the texture sample icon based on the graphics metadata and display the texture sample icon in the icon window 1110 for each texture sample stored in the SPDS 150. The SR engine 140 can also display relevant text adjacent to each texture sample icon, such as the texture sample identifier and/or the associated object (as specified in the sample identifier field 340 and associated object field 350).

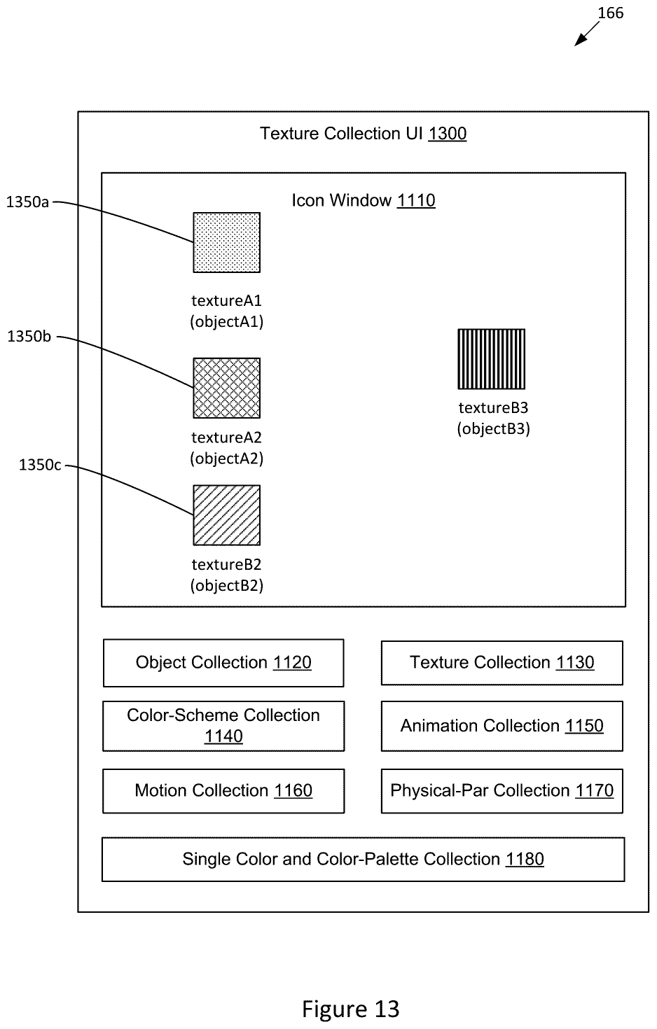

If the user selects the color-scheme collection 1140, the SR engine 140 generates and displays a color-scheme collection UI. FIG. 14 illustrates a color-scheme collection UI 1400 of the SPUI 166 of FIG. 1, according to various embodiments. As shown, the color-scheme collection UI 1400 continues to display the icon window 1110 and the plurality of selectable collections 1120-1180 displayed in the sample collection menu 1100. In addition, the SR engine 140 populates the icon window 1110 with zero or more color-scheme sample icons 1450 (such as 1450a, 1450b, 1450c, etc.) representing zero or more current color-scheme samples stored in the SPDS 150. In particular, the SR engine 140 can access the color-scheme section 310 in the SPDS 150 that stores zero or more color-scheme entries 312, each color-scheme entry 312 representing a color-scheme sample. For each color-scheme entry 312, the SR engine 140 can access the sample icon field 380 to retrieve the graphics metadata for rendering a color-scheme sample icon that visually represents the color-scheme sample. The SR engine 140 can then render the color-scheme sample icon based on the graphics metadata and display the color-scheme sample icon in the icon window 1110 for each color-scheme sample stored in the SPDS 150. The SR engine 140 can also display relevant text adjacent to each color-scheme sample icon, such as the color-scheme sample identifier and/or the associated object (as specified in the sample identifier field 340 and associated object field 350).

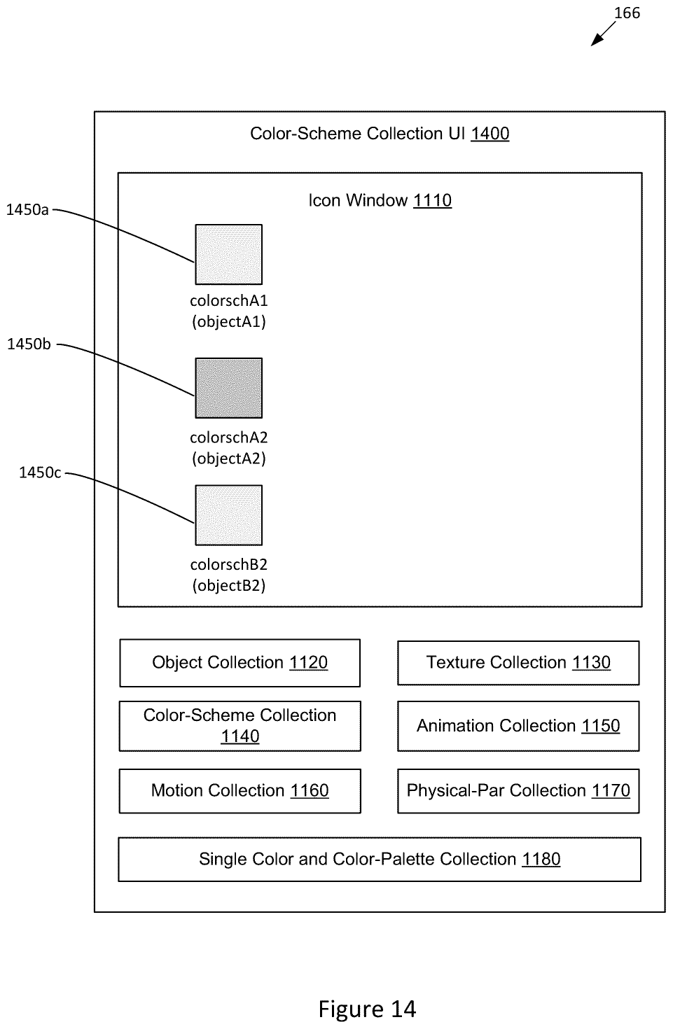

If the user selects the animation collection 1150, the SR engine 140 generates and displays an animation collection UI. FIG. 15 illustrates an animation collection UI 1500 of the SPUI 166 of FIG. 1, according to various embodiments. As shown, the animation collection UI 1500 continues to display the icon window 1110 and the plurality of selectable collections 1120-1180 displayed in the sample collection menu 1100. In addition, the SR engine 140 populates the icon window 1110 with zero or more animation sample icons 1550 (such as 1550a, 1550b, etc.) representing zero or more current animation samples stored in the SPDS 150. In particular, the SR engine 140 can access the animation section 314 in the SPDS 150 that stores zero or more animation entries 316, each animation entry 316 representing an animation sample. For each animation entry 316, the SR engine 140 can access the sample icon field 380 to retrieve the graphics metadata for rendering an animation sample icon that visually represents the animation sample. The SR engine 140 can then render the animation sample icon based on the graphics metadata and display the animation sample icon in the icon window 1110 for each animation sample stored in the SPDS 150. The SR engine 140 can also display relevant text adjacent to each animation sample icon, such as the animation sample identifier and/or the associated object (as specified in the sample identifier field 340 and associated object field 350).

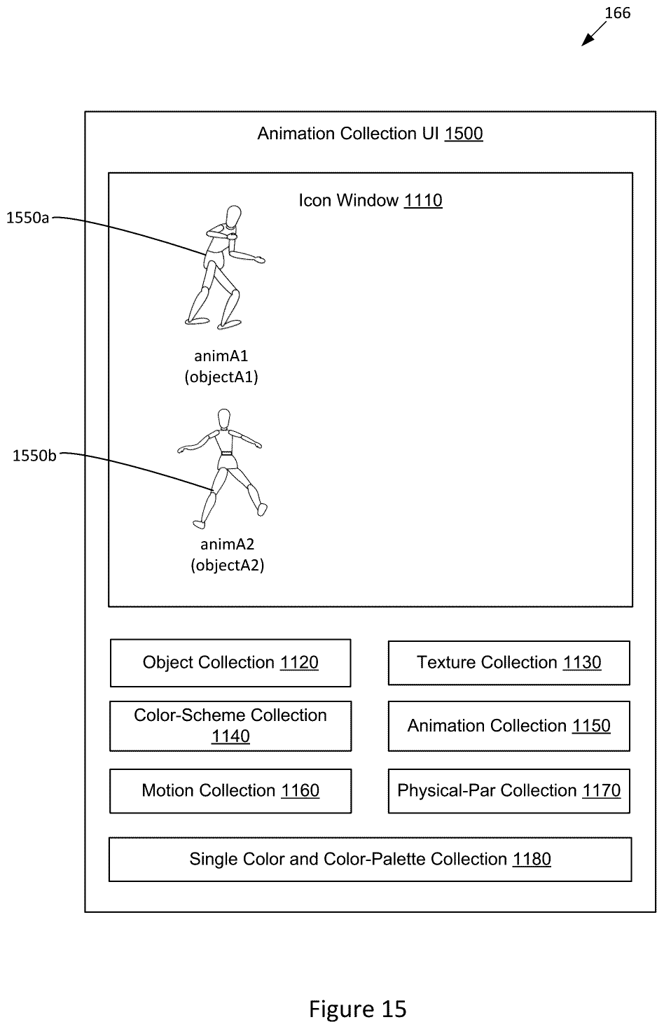

If the user selects the motion collection 1160, the SR engine 140 generates and displays a motion collection UI. FIG. 16 illustrates a motion collection UI 1600 of the SPUI 166 of FIG. 1, according to various embodiments. As shown, the motion collection UI 1600 continues to display the icon window 1110 and the plurality of selectable collections 1120-1180 displayed in the sample collection menu 1100. In addition, the SR engine 140 populates the icon window 1110 with zero or more motion sample icons 1650 (such as 1650a, 1650b, etc.) representing zero or more current motion samples stored in the SPDS 150. In particular, the SR engine 140 can access the motion section 318 in the SPDS 150 that stores zero or more motion entries 320, each motion entry 320 representing a motion sample. For each motion entry 320, the SR engine 140 can access the sample icon field 380 to retrieve the graphics metadata for rendering a motion sample icon that visually represents the motion sample. The SR engine 140 can then render the motion sample icon based on the graphics metadata and display the motion sample icon in the icon window 1110 for each motion sample stored in the SPDS 150. The SR engine 140 can also display relevant text adjacent to each motion sample icon, such as the motion sample identifier and/or the associated object (as specified in the sample identifier field 340 and associated object field 350).

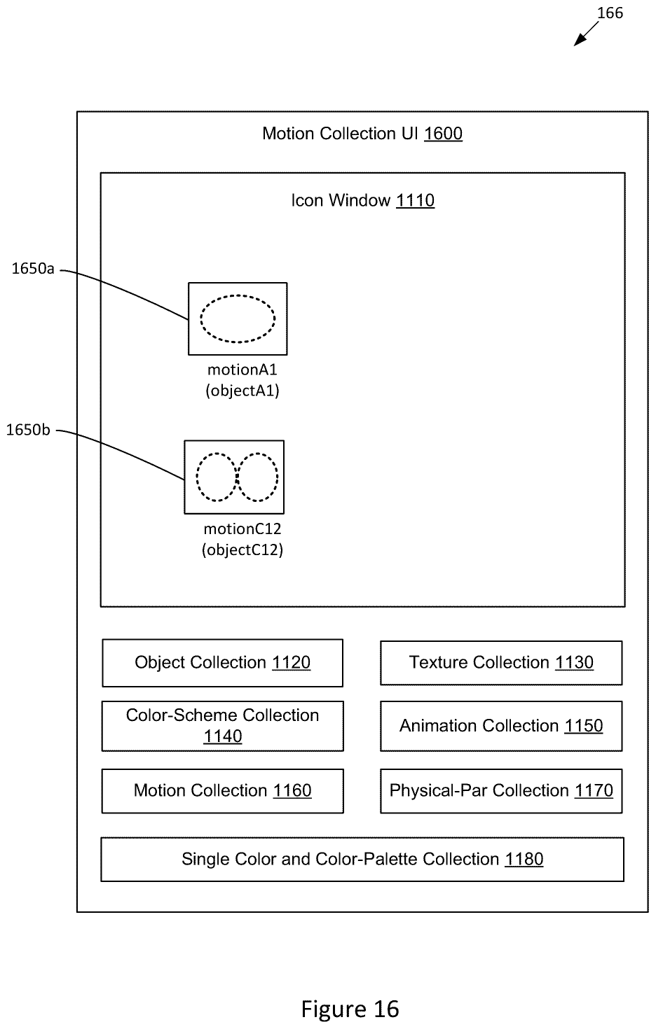

If the user selects the physical-parameters collection 1170, the SR engine 140 generates and displays a physical-parameters collection UI. FIG. 17 illustrates a physical-parameters collection UI 1700 of the SPUI 166 of FIG. 1, according to various embodiments. As shown, the physical-parameters collection UI 1700 continues to display the icon window 1110 and the plurality of selectable collections 1120-1180 displayed in the sample collection menu 1100. In addition, the SR engine 140 populates the icon window 1110 with zero or more physical-parameters sample icons 1750 (such as 1750a, 1750b, etc.) representing zero or more current physical-parameters samples stored in the SPDS 150. In particular, the SR engine 140 can access the physical-parameters section 322 in the SPDS 150 that stores zero or more physical-parameters entries 324, each physical-parameters entry 324 representing a physical-parameters sample. For each physical-parameters entry 324, the SR engine 140 can access the sample icon field 380 to retrieve the text and/or graphics metadata for rendering a physical-parameters sample icon that visually represents the physical-parameters sample. The SR engine 140 can then render the physical-parameters sample icon based on the text and/or graphics metadata and display the physical-parameters sample icon in the icon window 1110 for each physical-parameters sample stored in the SPDS 150. In some embodiments, a physical-parameters sample icon 1750 comprises text data specifying values for the various physical parameters captured in the corresponding physical-parameters sample (such as Par1_A1, Par2_A1, Par3_A1, Par4_A1, etc.). The SR engine 140 can also display relevant text adjacent to each physical-parameters sample icon, such as the physical-parameters sample identifier and/or the associated object (as specified in the sample identifier field 340 and associated object field 350).

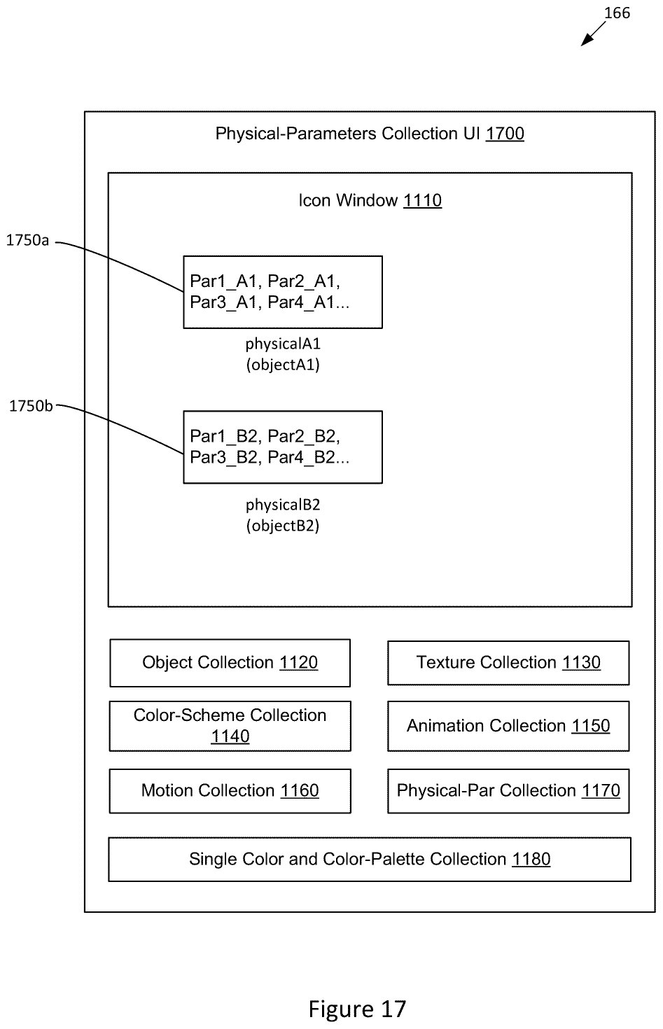

If the user selects the single-color and color-palette collection 1180, the SR engine 140 generates and displays a single-color and color-palette collections UI. FIG. 18 illustrates a single-color and color-palette collections UI 1800 of the SPUI 166 of FIG. 1, according to various embodiments. As shown, the single-color and color-palette collections UI 1800 continues to display the icon window 1110 and the plurality of selectable collections 1120-1180 displayed in the sample collection menu 1100. In addition, the SR engine 140 populates the icon window 1110 with zero or more single-color sample icons 1850 (such as 1850a, 1850b, etc.) representing zero or more current single-color samples stored in the SPDS 150 and zero or more color-palette sample icons 1890 (such as 1890a, 1890b, etc.) representing zero or more current color-palette samples stored in the SPDS 150. The icon window 1110 also includes a selectable “Global Selection” button 1892 for use during the remix stage.

In particular, the SR engine 140 can access the single-color section 326 in the SPDS 150 that stores zero or more single-color entries 328, each single-color entry 328 representing a single-color sample. For each single-color entry 328, the SR engine 140 can access the sample icon field 380 to retrieve the graphics metadata for rendering a single-color sample icon that visually represents the single-color sample. The SR engine 140 can then render the single-color sample icon based on the graphics metadata and display the single-color sample icon in the icon window 1110 for each single-color sample stored in the SPDS 150. The SR engine 140 can also display relevant text adjacent to each single-color sample icon, such as the single-color sample identifier (as specified in the sample identifier field 340).

In particular, the SR engine 140 can access the color-palette section 330 in the SPDS 150 that stores zero or more color-palette entries 332, each color-palette entry 332 representing a color-palette sample. For each color-palette entry 332, the SR engine 140 can access the sample icon field 380 to retrieve the graphics metadata for rendering a color-palette sample icon that visually represents the color-palette sample. The SR engine 140 can then render the color-palette sample icon based on the graphics metadata and display the color-palette sample icon in the icon window 1110 for each color-palette sample stored in the SPDS 150. The SR engine 140 can also display relevant text adjacent to each color-palette sample icon, such as the color-palette sample identifier (as specified in the sample identifier field 340).

In addition, each of the collection UIs 1200, 1300, 1400, 1500, 1600, 1700, and 1800 can provide functionality to manage and organize the samples stored in the SPDS 150. In some embodiments, each of the collection UIs allow the user to rename samples, for example, by clicking on a sample icon to rename the sample icon (provide a new sample identifier for the sample icon), which automatically modifies the sample identifier 340 stored in the corresponding sample entry in the SPDS 150. In other embodiments, each of the collection UIs allow the user to delete samples, for example, by selecting a sample icon to delete the sample icon, which automatically deletes the corresponding sample entry stored in the SPDS 150.

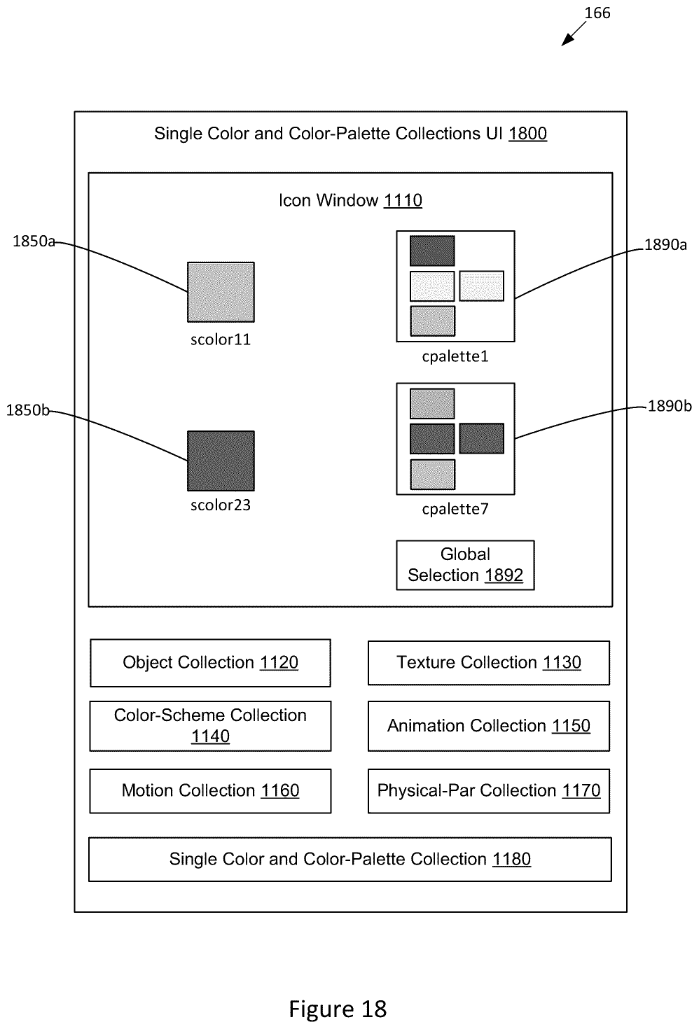

FIGS. 19A-19B set forth a flow diagram of method steps for capturing samples within a 3D immersive environment and viewing samples in the SPUI, according to various embodiments. Although the method steps are described in conjunction with the systems of FIGS. 1-18, persons skilled in the art will understand that the method steps can be performed in any order by any system. In some embodiments, the method 1900 can be performed by the computer system 106 (via the memory unit 104 and processor 102) of the IE system 100 of FIG. 1.

The method 1900 begins when the SR engine 140 configures (at step 1910) a sampling mode 410 for a particular sampling immersive environment 132 based on user input. The user input is received by the SR engine 140 for entering a sampling mode 410 for a particular immersive environment, referred to as the sampling immersive environment 132. In response, the SR engine 140 retrieves the selected sampling immersive environment 132 from the IE database 180 and initiates the IE engine 110 to render and display the selected sampling immersive environment 132 on the IE headset 172. In particular, the user input can include a selection of the sampling mode 410 from the mode UI 400 and specify a particular IE identifier 210 for the selected sampling immersive environment 132. The SR engine 140 can then identify the IE entry 230 corresponding to the IE identifier 210 and retrieve metadata from the associated objects field 220 in the corresponding IE entry 230, which includes metadata for one or more 3D objects associated with the selected sampling immersive environment 130. The IE engine 110 then renders and displays the sampling immersive environment 132 including the one or more associated 3D objects based on the retrieved metadata in the IE headset 172. The SR engine 140 also generates and displays the sampling UI 500 within the sampling immersive environment 132 on the IE headset 172, the sampling UI 500 displaying selectable options for a segmentation operation 510, an entire object sample 520, a texture sample 530, a color-scheme sample 540, an animation sample 550, a motion sample 560, a physical-parameters sample 570, a single-color sample 580, and a color-palette sample 590. Using the IE controllers 176, the user can then explore the sampling immersive environment 132 and select 3D digital components to sample/capture via the sampling UI 500.

At step 1920, the SR engine 140 segments a particular 3D object within the sampling immersive environment 132 based on user input. The user input received by the SR engine 140 includes a selection of the particular 3D object and a selection of the segmentation operation 510 from the sampling UI 500. In response, the SR engine 140 executes a segmentation algorithm on the selected 3D object to separate the 3D object into two or more sub-parts. The SR engine 140 then adds each sub-part of the selected 3D object as a separate and independent 3D object associated with the sampling immersive environment 132 in the IE entry 230 corresponding to the sampling immersive environment 132 in the IE database 180. Each sub-part of the selected 3D object is now selectable as a 3D object the same as any other 3D object within the sampling immersive environment 132.

At step 1930, the SR engine 140 captures at least one object-based sample of a 3D digital component within the sampling immersive environment 132 based on user input. The user input received by the SR engine 140 can include a selection of a particular 3D object, and in response, the SR engine 140 retrieves the object metadata (object_meta) associated with the selected 3D object from the IE database 18. The SR engine 140 then parses the object metadata into different types of object property metadata, including texture metadata (texture_meta), color-scheme metadata (colorsch_meta), animation metadata (anim_meta), motion metadata (motion_meta), and the physical parameters metadata (physical_meta). The SR engine 140 then highlights/indicates the selectable options in the sampling UI 500 that are available for the selected 3D object based on the parsed metadata found available for the selected 3D object. The user input received by the SR engine 140 can further specify at least one sample selection from the sampling UI 500, such as the object sample 520, the texture sample 530, the color-scheme sample 540, the animation sample 550, the motion sample 560, and/or the physical-parameters sample 570. The SR engine 140 then captures at least one new sample by generating at least one new entry in the SPDS 150 for representing the at least one new sample and filling in one or more data fields 340, 350, 360, 370, and/or 380 for the at least one new entry, as described in relation to FIG. 5. In this manner, one or more new object-based samples for the selected 3D object can be generated and stored to the SPDS 150, including any combination of an object sample, a texture sample, a color-scheme sample, an animation sample, a motion sample, and/or a physical-parameters sample.

At step 1940, the SR engine 140 identifies and displays one or more object-based sample suggestions within the sampling immersive environment 132, for example, based on the 3D object currently selected in step 1930. A sample suggestion can comprise a 3D object in the IE database 180 that is identified as relevant to the currently selected 3D object, an object property component of the identified 3D object, and/or a standard default object property component that is relevant to the currently selected 3D object. The SR engine 140 can generate a visualization icon for each sample suggestion and display the visualization icons in a suggestion window (such as 1010 or 1020) within the sampling immersive environment 132, as discussed in relation to FIG. 10.

At step 1950, the SR engine 140 captures an object-based sample of a sample suggestion within the sampling immersive environment 132 based on user input. The user input that is received by the SR engine 140 can comprise a selection of a particular visualization icon displayed in the suggestion window. In response, the SR engine 140 can generate and store a new sample entry representing the new object-based sample in the SPDS 150. An object property sampled in this manner can also be associated with the currently selected 3D object, as indicated in the associated object field 350 for the new sample entry.

At step 1960, the SR engine 140 captures at least one color-based sample of a 3D digital component within the sampling immersive environment 132 based on user input. The user input received by the SR engine 140 can include a selection of a single-color sample 580 in the sampling UI 500 and a selection of a particular location/point within the sampling immersive environment 132. In response, the SR engine 140 captures a new single-color sample by generating a new entry in the SPDS 150 for representing the new single-color sample and filling in one or more data fields 340, 350, 360, 370, and/or 380 for the new entry, as described in relation to FIG. 8. Alternatively or in addition to, the user input received by the SR engine 140 can include a selection of a color-palette sample 590 in the sampling UI 500 and a selection of multiple 3D objects within the sampling immersive environment 132. In response, the SR engine 140 captures a new color-palette sample by generating a new entry in the SPDS 150 for representing the new color-palette sample and filling in one or more data fields 340, 350, 360, 370, and/or 380 for the new entry, as described in relation to FIG. 9.

At step 1970, the SR engine 140 identifies and displays one or more color-based sample suggestions within the sampling immersive environment 132 based on the current color-based sample captured in step 1960. A sample suggestion can comprise an image from an image server 190 that is identified as being relevant to the current color-based sample.

At step 1972, the SR engine 140 captures a color-based sample from a sample suggestion based on user input. The user input received by the SR engine 140 can include a selection of a single-color sample 580 in the sampling UI 500 and a selection of a particular location/point within a suggested image. In response, the SR engine 140 captures a new single-color sample based on the selected location/point by generating a new entry in the SPDS 150 for representing the new single-color sample and filling in one or more data fields 340, 350, 360, 370, and/or 380 for the new entry, as described in relation to FIG. 8. Alternatively, the user input received by the SR engine 140 can include a selection of a color-palette sample 590 in the sampling UI 500 and a selection of a suggested image. In response, the SR engine 140 captures a new color-palette sample based on the selected suggested image by generating a new entry in the SPDS 150 for representing the new color-palette sample and filling in one or more data fields 340, 350, 360, 370, and/or 380 for the new entry, as described in relation to FIG. 9.

At step 1976, the SR engine 140 receives a user selection for the sample palette mode 420 from the mode UI 400 to view samples currently stored to the SPDS 150. At any time during the sampling stage within the sampling immersive environment 132 or the remix stage within the remix immersive environment 134, the user can select the sample palette mode 420 from the mode UI 400. In response, the SR engine 140 generates and displays a sample collection menu 1100 comprising an icon window 1110 and a plurality of selectable collections for viewing, including an object collection 1120, a texture collection 1130, color-scheme collection 1140, animation collection 1150, motion collection 1160, physical-parameters collection 1170, and a single-color and color-palette collection 1180. The icon window 1110 is initially empty and is populated with sample icons once a sample collection is selected.

At step 1978, the SR engine 140 receives a user selection of the object collection 1120 from the sample collection menu 1100. In response, the SR engine 140 generates and displays an object collection UI 1200 that displays zero or more object sample icons 1250 representing zero or more object samples stored in the SPDS 150 in the icon window 1110, as described in relation to FIG. 12. To do so, the SR engine 140 can access zero or more object entries 304 stored in the object section 302 in the SPDS 150, and for each object entry 304, access the sample icon field 380 to retrieve the graphics metadata for rendering and displaying an object sample icon in the icon window 1110.

At step 1980, the SR engine 140 receives a user selection of the texture collection 1130 from the sample collection menu 1100. In response, the SR engine 140 generates and displays a texture collection UI 1300 that displays zero or more texture sample icons 1350 representing zero or more texture samples stored in the SPDS 150 in the icon window 1110, as shown in FIG. 13. To do so, the SR engine 140 can access zero or more texture entries 308 stored in the texture section 306 in the SPDS 150, and for each texture entry 308, access the sample icon field 380 to retrieve the graphics metadata for rendering and displaying a texture sample icon in the icon window 1110.

At step 1982, the SR engine 140 receives a user selection of the color-scheme collection 1140 from the sample collection menu 1100. In response, the SR engine 140 generates and displays a color-scheme collection UI 1400 that displays zero or more color-scheme sample icons 1450 representing zero or more color-scheme samples stored in the SPDS 150 in the icon window 1110, as shown in FIG. 14. To do so, the SR engine 140 can access zero or more color-scheme entries 312 stored in the color-scheme section 310 in the SPDS 150, and for each color-scheme entry 312, access the sample icon field 380 to retrieve the graphics metadata for rendering and displaying a color-scheme sample icon in the icon window 1110.

At step 1984, the SR engine 140 receives a user selection of the animation collection 1150 from the sample collection menu 1100. In response, the SR engine 140 generates and displays an animation collection UI 1500 that displays zero or more animation sample icons 1550 representing zero or more animation samples stored in the SPDS 150 in the icon window 1110, as shown in FIG. 15. To do so, the SR engine 140 can access zero or more animation entries 316 stored in the animation section 314 in the SPDS 150, and for each animation entry 312, access the sample icon field 380 to retrieve the graphics metadata for rendering and displaying an animation sample icon in the icon window 1110.

At step 1986, the SR engine 140 receives a user selection of the motion collection 1160 from the sample collection menu 1100. In response, the SR engine 140 generates and displays a motion collection UI 1600 that displays zero or more motion sample icons 1650 representing zero or more motion samples stored in the SPDS 150 in the icon window 1110, as shown in FIG. 16. To do so, the SR engine 140 can access zero or more motion entries 320 stored in the motion section 318 in the SPDS 150, and for each motion entry 320, access the sample icon field 380 to retrieve the graphics metadata for rendering and displaying a motion sample icon in the icon window 1110.

At step 1988, the SR engine 140 receives a user selection of the physical-parameters collection 1170 from the sample collection menu 1100. In response, the SR engine 140 generates and displays a physical-parameters collection UI 1700 that displays zero or more physical-parameters sample icons 1750 representing zero or more physical-parameters samples stored in the SPDS 150 in the icon window 1110, as shown in FIG. 17. To do so, the SR engine 140 can access zero or more physical-parameters entries 324 stored in the physical-parameters section 322 in the SPDS 150, and for each physical-parameters entry 324, access the sample icon field 380 to retrieve the text and/or graphics metadata for rendering and displaying a physical-parameters sample icon in the icon window 1110.

At step 1990, the SR engine 140 receives a user selection of the single-color and color-palette collection 1180 from the sample collection menu 1100. In response, the SR engine 140 generates and displays a single-color and color-palette collection UI 1800 that displays zero or more single-color icons 1850 representing zero or more single-color samples and zero or more color-palette sample icons 1890 representing zero or more color-palette samples stored in the SPDS 150 in the icon window 1110, as shown in FIG. 18. To do so, the SR engine 140 can access zero or more single-color entries 328 stored in the single-color section 326 and zero or more color-palette entries 332 stored in the color-palette section 330 in the SPDS 150, and for each entry 328 or 332, access the sample icon field 380 to retrieve the graphics metadata for rendering and displaying a single-color sample icon 1850 or color-palette sample icon 1890 in the icon window 1110.

At step 1992, the SR engine 140 reuses a sampled 3D digital component (stored as a sample in the SPDS 150) within a remix immersive environment 134 based on user input. As discussed below, reusing a sampled 3D digital component can include, among other things, associating a sampled 3D object with the remix immersive environment 134 to modify the remix immersive environment 134 to generate a new immersive environment, or replacing an object property of a 3D object with a sampled 3D digital component to generate a new/modified 3D object.

### Reusing and Remixing Samples within a Remix Immersive Environment

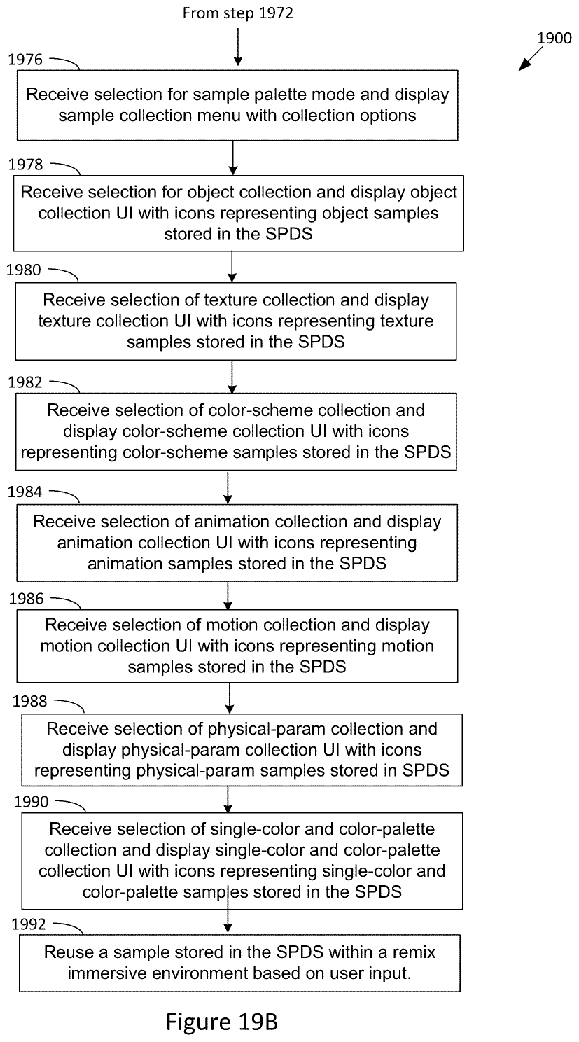

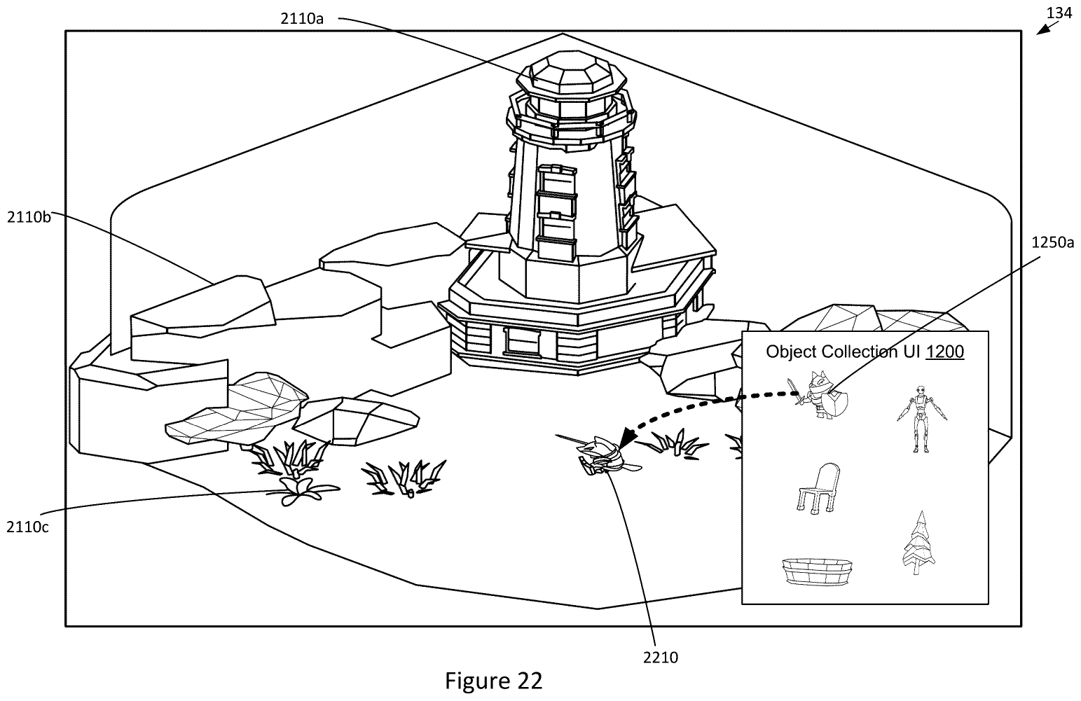

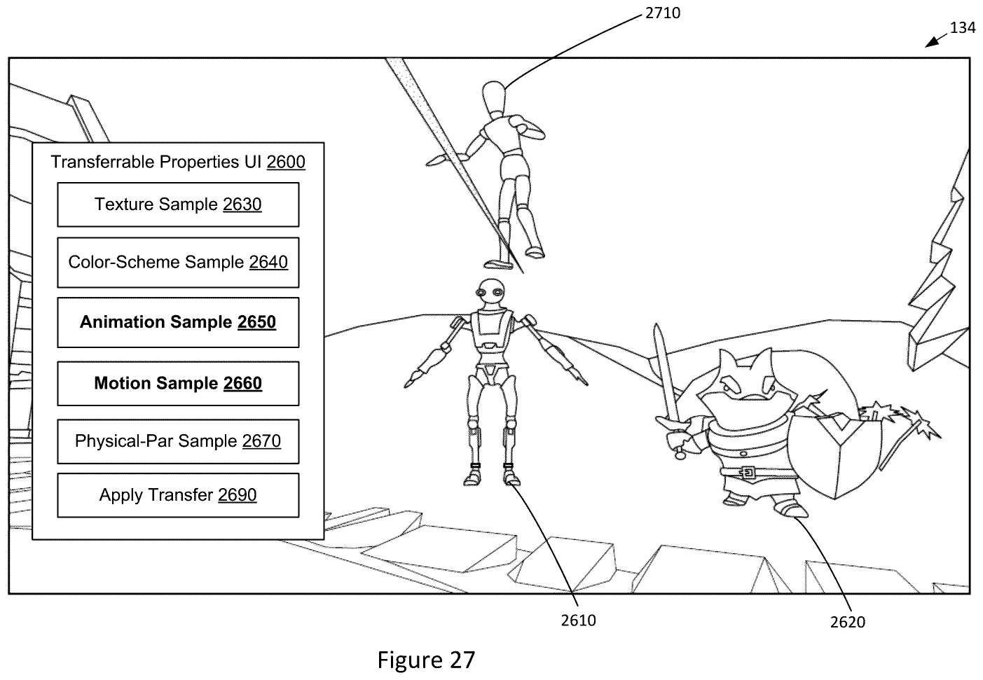

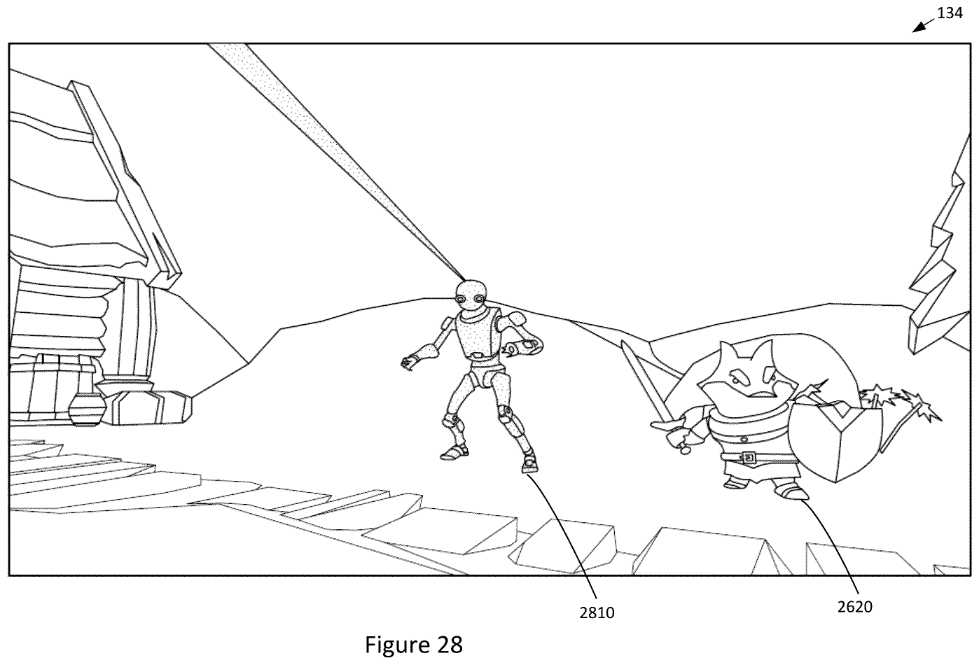

In some embodiments, the SPUI 166 can be used to access and view samples stored in the SPDS 150 to reuse/apply samples in a remix immersive environment 134. For example, reusing a sample can include adding an object sample of a 3D object from a first immersive environment to a second immersive environment (the remix immersive environment 134), to produce a new third immersive environment (as discussed below in relation to FIGS. 21-23). As another example, reusing a sample can include modifying an object property of a 3D object using a sample from the SPDS 150 to generate a new/modified 3D object, referred to as “remixing” (as discussed below in relation to FIGS. 24-28). As a further example, reusing a sample can include modifying a color-scheme property of multiple 3D objects of an IE scene using a color-palette sample from the SPDS 150 to generate new/modified multiple 3D objects of a new IE scene, also referred to as “remixing” (as discussed below in relation to FIGS. 29-30).

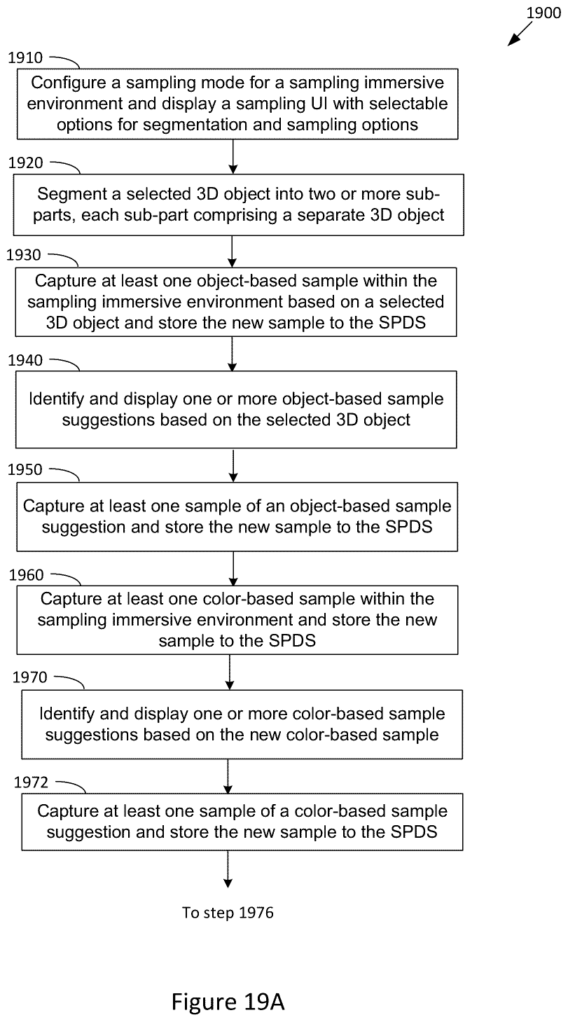

At any time, to enter the reuse/remix stage, the user can select the remix mode 430 from the mode UI 400 displayed in the IE scene 174. In response to the user selection of the remix mode 430, the SR engine 140 (as stored in the memory unit 104 and executed by the processor 102 of FIG. 1) generates and displays a remix IE selection menu to select a remix immersive environment 134. FIG. 20 is a screenshot of a remix IE selection menu 2000 displayed in the sampling immersive environment 132 of FIG. 1, according to various embodiments. As shown, the remix IE selection menu 2000 displays options for selecting a default remix IE 2010 or a specific user-selected remix IE 2020. In response to the selection for the remix immersive environment 134 (either the default or the user-selected remix immersive environment 134), the SR engine 140 retrieves the selected remix immersive environment 134 from the IE database 180 and initiates the IE engine 110 to render and display the remix immersive environment 134 on the IE headset 172. In some embodiments, the remix immersive environment 134 is different from the sampling immersive environment 132. In other embodiments, the remix immersive environment 134 can be the same as the sampling immersive environment 132.

A default remix immersive environment 134 can comprise an immersive environment stored to the IE database 180 that comprises a plain/simple immersive environment with minimal 3D objects. The user can select the default remix IE 2010, for example, if the user wishes to modify particular 3D objects using samples from the SPDS 150 from within a plain/simple remix immersive environment 134. A user-selected remix IE 2020 comprises a particular immersive environment stored to the IE database 180 that the user wishes to select as the remix immersive environment 134. The user can select the user-selected remix IE 2020, for example, if the user desires to modify the selected remix immersive environment 134 to generate a new immersive environment that can be stored to the IE database 180. Note that the user can also modify particular 3D objects using samples from the SPDS 150 within a user-selected remix immersive environment 134.

As described below in relation to FIGS. 21-23, a user can add sampled 3D objects to an initial remix immersive environment 134 to modify the remix immersive environment 134, which generates a new remix immersive environment 134. FIG. 21 is a screenshot of the remix immersive environment 134 of FIG. 1, according to various embodiments. In the example of FIG. 21, the remix immersive environment 134 comprises a user-selected remix immersive environment 134 comprising a simulated lighthouse environment. As shown, the remix immersive environment 134 can comprise one or more native 3D objects 2110 (such as 2110a, 2110b, 2110c, etc.) that includes objects such as building/structure objects and landscape objects (boulders, trees, vegetation, and the like). As used herein, a native 3D object of a remix immersive environment 134 comprises a 3D object that is included in the original/initial remix immersive environment 134 before the remix immersive environment 134 is modified via the samples from the SPDS 150. In some embodiments, a native 3D object is not a sampled object and does not derive from a sampled object.

As shown, the SR engine 140 also generates and displays the sample collection menu 1100 of the SPUI 166 within the remix immersive environment 134. As discussed above in relation to FIG. 11, the sample collection menu 1100 comprises an icon window 1110 and a plurality of selectable collections for viewing, including an object collection 1120, a texture collection 1130, color-scheme collection 1140, animation collection 1150, motion collection 1160, physical-parameters collection 1170, and a single-color and color-palette collection 1180 (not shown). To add 3D objects to the initial remix immersive environment 134, the user can select the object collection 1120 from the sample collection menu 1100. In response, the SR engine 140 generates and displays the object collection UI 1200 and populates the icon window 1110 with zero or more object sample icons 1250 (such as 1250a, 1250b, 1250c, etc.) representing zero or more current object samples stored in the SPDS 150, as described in relation to FIG. 12. The user can then interact with the object collection UI 1200 to add sampled 3D objects to the remix immersive environment 134.

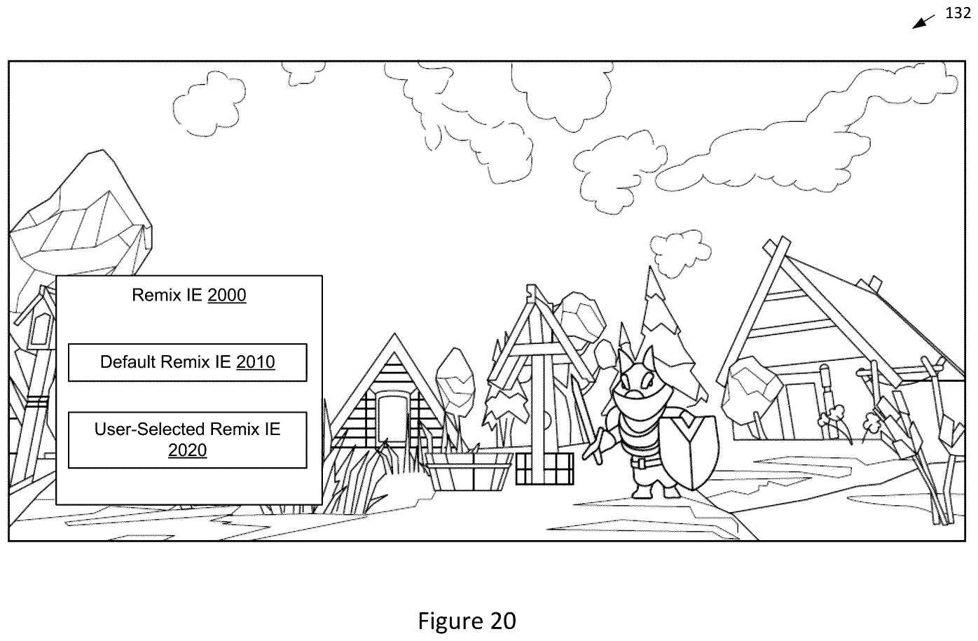

FIG. 22 is a screenshot of a sampled object added to the remix immersive environment 134 of FIG. 1, according to various embodiments. In the example of FIG. 22, the user has selected a fox icon 1250a from the object collection UI 1200 corresponding to a fox object sample of a fox object 2210 stored to the SPDS 150. The user has dragged the fox icon 1250a into the remix immersive environment 134 (as indicated by the dashed arrow), which indicates that the user wishes to add the sampled fox object to the remix immersive environment 134. In response, the SR engine 140 retrieves the object entry 304 corresponding to the selected fox icon 1250a in the SPDS 150, and renders and displays the fox object 2210 within the remix immersive environment 134 based on the sample metadata 360 stored in the retrieved object entry 304.

In response to the user dragging the fox icon 1250a into the remix immersive environment 134, the SR engine 140 can also store the fox object 2210 as a new object associated with the remix immersive environment 134 stored in the IE database 180. The SR engine 140 can do so by accessing the IE entry 230 corresponding to the remix immersive environment 134 in the IE database 180 and adding the object identifier for the fox object and the fox object metadata (object_meta) to the associated objects field 220 in the corresponding IE entry 230. By doing so, the initial remix immersive environment 134 is modified to generate a new remix immersive environment 134 that includes the new associated fox object 2210. In this manner, a 3D object sampled from within a first immersive environment can be reused in (added to) a second immersive environment to modify the second immersive environment, which generates a new third immersive environment. Note that the second immersive environment is different from the first immersive environment.

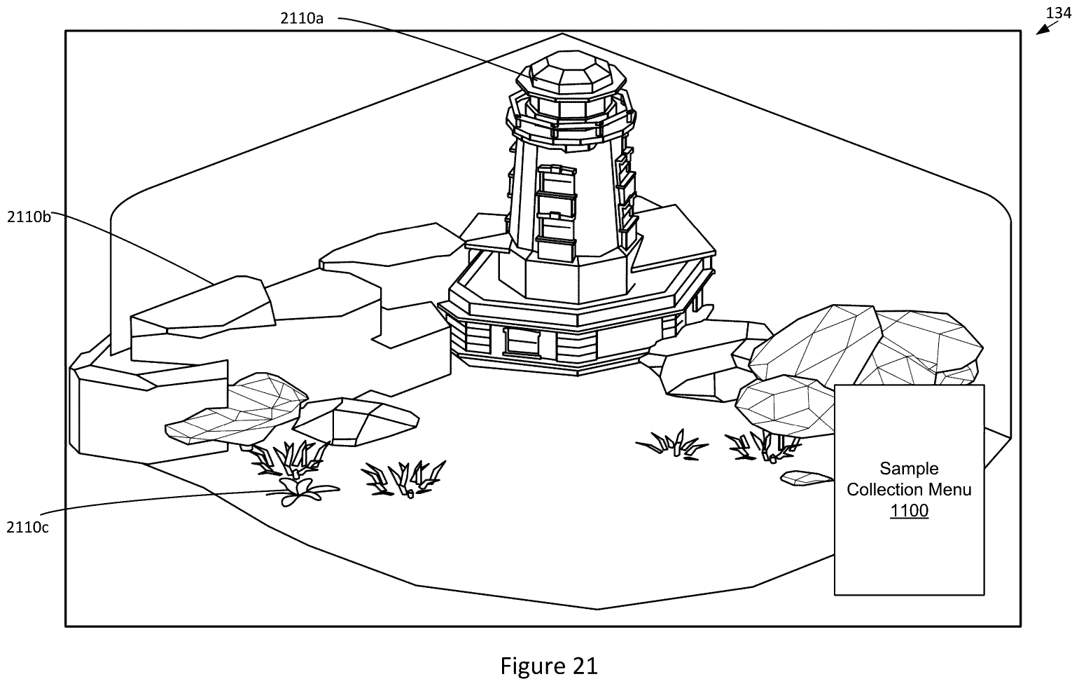

FIG. 23 is a screenshot of additional sampled objects added to the remix immersive environment 134 of FIG. 1, according to various embodiments. In the example of FIG. 23, the user has included additional 3D objects 2310 (such as 2310a, 2310b, 2310c) to the remix immersive environment 134 via selection and dragging of the corresponding object icons 1250 from the object collection UI 1200 into the remix immersive environment 134. In response, the SR engine 140 retrieves the object entries 304 corresponding to the selected icons 1250 from the SPDS 150 and renders and displays the additional objects 2310 within the remix immersive environment 134 based on the sample metadata 360 in the corresponding object entries 304. The SR engine 140 can also store the additional objects 2310 as new objects associated with the remix immersive environment 134 in the corresponding IE entry 230 stored in the IE database 180 to further modify the remix immersive environment 134.

In some embodiments, a sample from the SPDS 150 can be used to modifying an object property of a 3D object displayed within the remix immersive environment 134 to generate a new 3D object, referred to as “remixing.” For example, to modify a particular object property of a 3D object, the user can select the collection UI corresponding to the particular object property from the sample collection menu 1100 to view sample icons for samples of the particular object property currently stored to the SPDS 150. The user can then select and drag a particular sample icon onto the 3D object to replace the current object property of the 3D object with the sampled object property corresponding to the selected sample icon.

FIG. 24 is a screenshot of a first object selected for remixing within the remix immersive environment 134 of FIG. 1, according to various embodiments. In the example of FIG. 24, the remix immersive environment 134 includes the sampled fox object 2210 of FIG. 22. In other embodiments, the fox object 2210 can comprise a native 3D object that does not comprise a sampled object and does not derive from a sampled object. In the example of FIG. 24, the user has selected the texture collection 1130 from the collection menu 1100, and in response, the SR engine 140 has generated and displayed the texture collection UI 1300 showing zero or more texture sample icons 1350 representing zero or more texture samples/entries 308 stored in the SPDS 150, as described in relation to FIG. 13. The user can then interact with the texture collection UI 1300 to modify a current texture property associated with the selected fox object 2210 within the remix immersive environment 134. As shown, the user has selected a first texture icon 1350a from the texture collection UI 1300 corresponding to a first texture sample of a first texture stored to the SPDS 150. The user has also dragged the first texture icon 1350a onto the fox object 2210 in the remix immersive environment 134 (as indicated by the dashed arrow), which indicates that the user wishes to transfer the first texture to the fox object 2210 (replace the current texture of the fox object 2210 with the first texture).

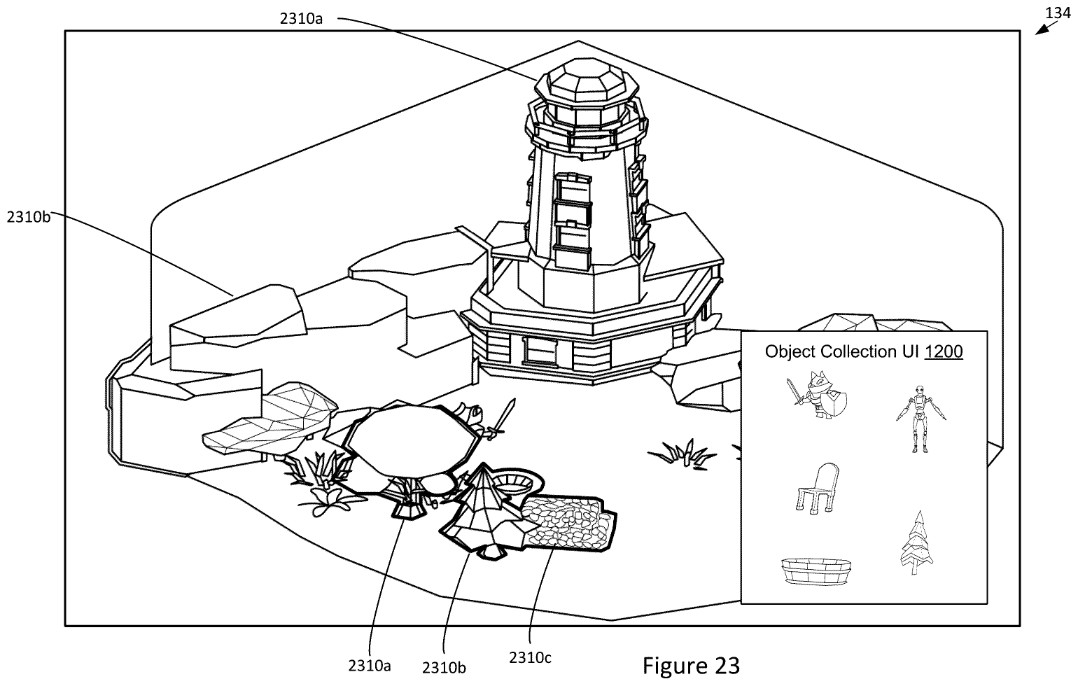

In response, the SR engine 140 retrieves the texture entry 308 corresponding to the first texture icon 1350a in the SPDS 150 and retrieves the texture metadata (texture_meta) in the sample metadata field 360 of the texture entry 308. The SR engine 140 then replaces the current texture metadata associated with the fox object 2210 (stored in the associated objects field 220 of the IE entry 230 corresponding to the remix immersive environment 134 in the IE database 180) with the retrieved texture metadata (texture_meta) for the first texture. FIGS. 25A-25B are close-up screenshots of a remixed first object within the remix immersive environment 134 of FIG. 1, according to various embodiments. FIG. 25A shows the initial fox object 2210 of FIG. 22 having the initial texture property. FIG. 25A shows the modified fox object 2510 having the first texture corresponding to the first texture icon 1350a after the texture sample is applied.

Likewise, the user can interact with other types of collection UIs to change other types of object properties of a 3D object within the remix immersive environment 134. To modify a color-scheme property of a 3D object, the user can select the color-scheme collection 1140 from the sample collection menu 1100. In response, the SR engine 140 generates and displays the color-scheme collection UI 1400 showing zero or more color-scheme sample icons 1450 representing zero or more color-scheme samples stored in the SPDS 150, as described in relation to FIG. 14. The user can then select a first color-scheme icon 1450 corresponding to a first color-scheme sample of a first color-scheme stored to the SPDS 150 and drag the first color-scheme icon 1450 onto a selected 3D object within the remix immersive environment 134. In response, the SR engine 140 retrieves a first color-scheme entry 328 corresponding to the first color-scheme icon 1450 in the SPDS 150 and retrieves the color-scheme metadata (colorsch_meta) in the sample metadata field 360 of the first color-scheme entry 328. The SR engine 140 then replaces the current color-scheme metadata associated with the selected 3D object (stored in the associated objects field 220 of the IE entry 230 corresponding to the remix immersive environment 134 in the IE database 180) with the retrieved color-scheme metadata (colorsch_meta) for the first color-scheme. In this manner, the color-scheme property of the selected 3D object is replaced with the first color-scheme sample to generate a new/modified 3D object.

Likewise, to modify an animation property of a 3D object, the user can select the animation collection 1150 from the sample collection menu 1100. In response, the SR engine 140 generates and displays the animation collection UI 1500 showing zero or more animation sample icons 1550 representing zero or more animation samples stored in the SPDS 150, as described in relation to FIG. 15. The user can then select a first animation icon 1550 corresponding to a first animation sample of a first animation stored to the SPDS 150 and drag the first animation icon 1550 onto a selected 3D object within the remix immersive environment 134. In response, the SR engine 140 retrieves a first animation entry 316 corresponding to the first animation icon 1550 in the SPDS 150 and retrieves the animation metadata (anim_meta) in the sample metadata field 360 of the first animation entry 316. The SR engine 140 then replaces the current animation metadata associated with the selected 3D object (stored in the associated objects field 220 of the IE entry 230 corresponding to the remix immersive environment 134 in the IE database 180) with the retrieved animation metadata (anim_meta) for the first animation. In this manner, the animation property of the selected 3D object is replaced with the first animation sample to generate a new/modified 3D object.

Likewise, to modify a motion property of a 3D object, the user can select the motion collection 1160 from the sample collection menu 1100. In response, the SR engine 140 generates and displays the motion collection UI 1600 showing zero or more motion sample icons 1650 representing zero or more motion samples stored in the SPDS 150, as described in relation to FIG. 16. The user can then select a first motion icon 1650 corresponding to a first motion sample of a first motion stored to the SPDS 150 and drag the first motion icon 1650 onto a selected 3D object within the remix immersive environment 134. In response, the SR engine 140 retrieves a first motion entry 320 corresponding to the first motion icon 1650 in the SPDS 150 and retrieves the motion metadata (motion_meta) in the sample metadata field 360 of the first motion entry 320. The SR engine 140 then replaces the current motion metadata associated with the selected 3D object (stored in the associated objects field 220 of the IE entry 230 corresponding to the remix immersive environment 134 in the IE database 180) with the retrieved motion metadata (motion_meta) for the first motion. In this manner, the motion property of the selected 3D object is replaced with the first motion sample to generate a new/modified 3D object.

Likewise, to modify a physical-parameters property of a 3D object, the user can select the physical-parameters collection 1170 from the sample collection menu 1100. In response, the SR engine 140 generates and displays the physical-parameters collection UI 1700 showing zero or more physical-parameters sample icons 1750 representing zero or more physical-parameters samples stored in the SPDS 150, as described in relation to FIG. 17. The user can then select a first physical-parameters icon 1750 corresponding to a first physical-parameters sample of a first physical-parameters stored to the SPDS 150 and drag the first physical-parameters icon 1750 onto a selected 3D object within the remix immersive environment 134. In response, the SR engine 140 retrieves a first physical-parameters entry 324 corresponding to the first physical-parameters icon 1750 in the SPDS 150 and retrieves the physical-parameters metadata (physical_meta) in the sample metadata field 360 of the first physical-parameters entry 324. The SR engine 140 then replaces the current physical-parameters metadata associated with the selected 3D object (stored in the associated objects field 220 of the IE entry 230 corresponding to the remix immersive environment 134 in the IE database 180) with the retrieved physical-parameters metadata (physical_meta) for the first physical-parameters. In this manner, the physical-parameters property of the selected 3D object is replaced with the first physical-parameters sample to generate a new/modified 3D object.

In addition, the color-scheme property of a 3D object can also be modified using a single-color sample stored to the SPDS 150. In these embodiments, the user can select the single-color and color-palette collections 1180 from the sample collection menu 1100. In response, the SR engine 140 generates and displays the single-color and color-palette collections UI 1800 showing zero or more single-color sample icons 1850 representing zero or more single-color samples stored in the SPDS 150, as described in relation to FIG. 18. The user can then select a first single-color icon 1850 corresponding to a first single-color sample of a first single-color stored to the SPDS 150 and drag the first single-color icon 1850 onto a selected 3D object within the remix immersive environment 134. In response, the SR engine 140 retrieves a first single-color entry 328 corresponding to the first single-color icon 1850 in the SPDS 150 and retrieves the single-color metadata (scolor_meta) in the sample metadata field 360 of the first single-color entry 328. The SR engine 140 then replaces the current color-scheme metadata associated with the selected 3D object (stored in the associated objects field 220 of the IE entry 230 corresponding to the remix immersive environment 134 in the IE database 180) with the retrieved single-color metadata (scolor_meta) for the first single-color. In this manner, the color-scheme property of the selected 3D object is replaced with the first single-color sample to generate a new/modified 3D object.

In some embodiments, one or more object properties of a first 3D object can be modified using multiple sampled object properties of a second 3D object. For example, the remix immersive environment 134 can include the first 3D object and the second 3D object. The user can select and drag the second 3D object onto the first 3D object, indicating that the user wishes to transfer one or more object properties of the second 3D object to the first 3D object. In response, the SR engine 140 can generate and display a transferrable properties UI that displays one or more object property samples of the second 3D object currently available and stored to the SPDS 150. The user can then interact with the transferrable properties UI to select and transfer one or more object properties of the second 3D object to the first 3D object.

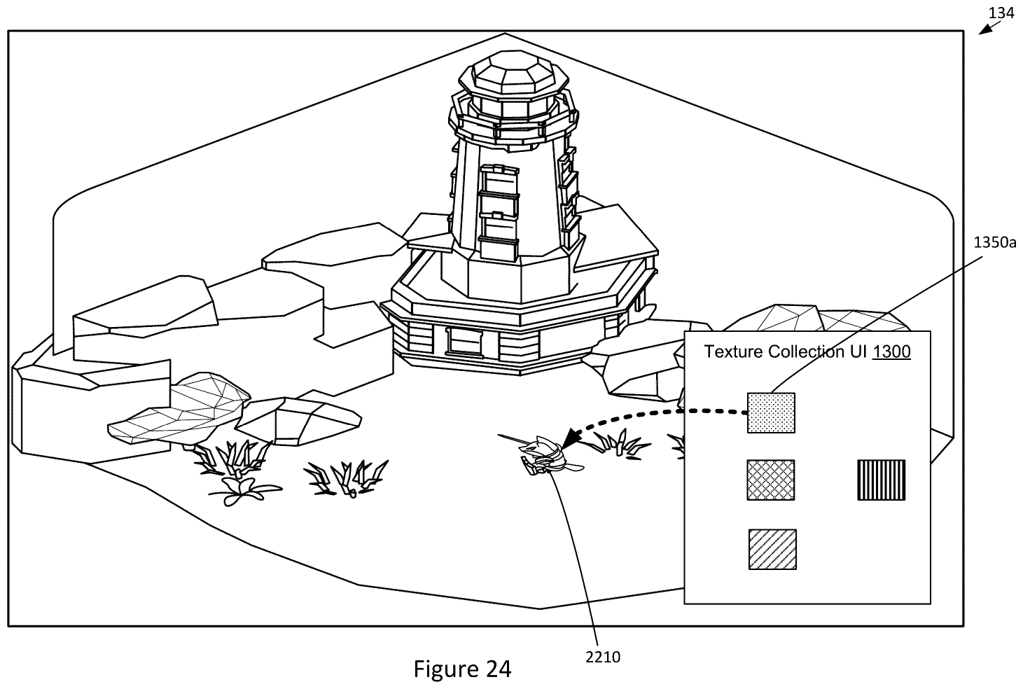

FIG. 26 is a screenshot of a first object selected for remixing with a second object within the remix immersive environment 134 of FIG. 1, according to various embodiments. In the example of FIG. 26, the remix immersive environment 134 includes a first object 2610 (robot object) and a second object 2620 (fox object). The first object 2160 can comprise a native object of the remix immersive environment 134 or a sampled object added to the remix immersive environment 134 via the SPUI 166. The second object 2260 comprises a sampled object stored to the SPDS 150 that was added to the remix immersive environment 134 via the SPUI 166, the second object 2260 having one or more associated sampled object properties also stored to the SPDS 150.

As shown, the user has selected and dragged the second object 2620 onto the first object 2610 (as indicated by the dashed arrow), indicating that the user wishes to transfer one or more object properties of the second object 2620 to the first object 2610. In response, the SR engine 140 can generate and display a transferrable properties UI 2600 that displays one or more object property samples of the second object 2620 currently available and stored to the SPDS 150. To do so, the SR engine 140 can retrieve all object property entries for object property samples associated with the second object 2620 in the SPDS 150, for example, by searching for the object identifier of the second object 2620 in the associated object field 350 of the entries in the SPDS 150. In some embodiments, the transferrable properties UI 2600 displays only the object property samples of the second object 2620 that were separately captured and stored to the SPDS 150 (which are separate from the object sample for the second object 2620).

In the example of FIG. 26, it is determined that all of the different types of object property samples of the second object 2620 were separately captured and stored to the SPDS 150, and thus the transferrable properties UI 2600 displays as available a texture sample 2630, a color-scheme sample 2640, an animation sample 2650, a motion sample 2660, and a physical-parameters sample 2670. In other embodiments, only a sub-set of the different types of object property samples of the second object 2620 were separately captured and stored to the SPDS 150, and thus the transferrable properties UI 2600 would display as available only a sub-set of the different types of samples. The transferrable properties UI 2600 also displays a selectable “Apply Transfer” button 2690.

The user can then select one or more object properties of the second object 2620 to transfer to the first object 2610 by selecting one or more available samples from the transferrable properties UI 2600. As shown, the user has selected to transfer the animation and motion object properties of the second object 2620 by selecting the animation sample 2650 and the motion sample 2660 (as indicated by the bolded text). In other embodiments, the user selects a different set of available samples from the transferrable properties UI 2600. The user can then select the “Apply Transfer” button 2690 to initiate the transfer process. In response, the SR engine 140 transfers one or more object properties of the second object 2620 to the first object 2610 using the remix and transfer operations discussed above in relation to FIGS. 24, 25A, and 25B.

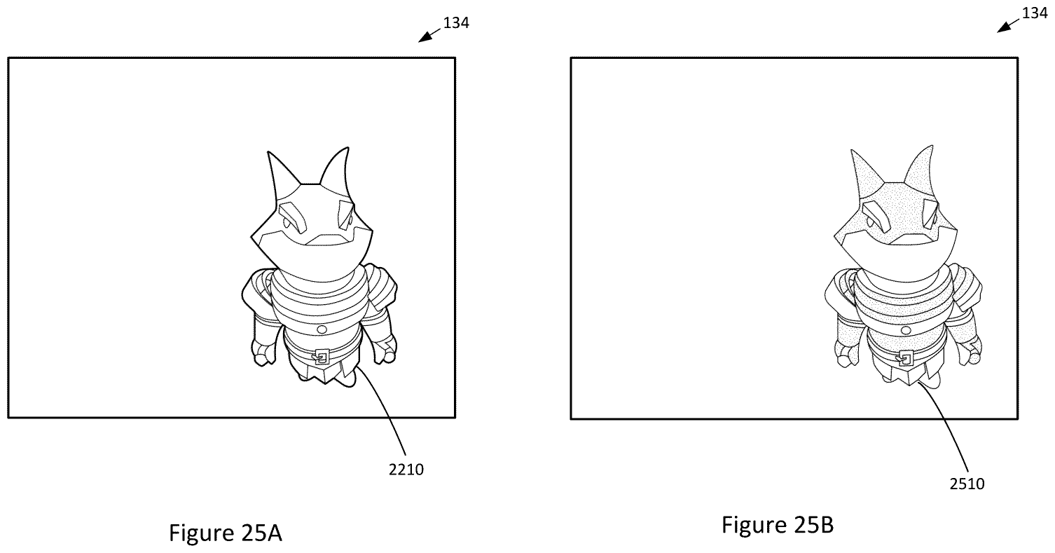

FIG. 27 is a screenshot of an animation property being transferred to the first object within the remix immersive environment 134 of FIG. 26, according to various embodiments. In some embodiments, the SR engine 140 can display a visualization 2710 of an object property transfer between the second object 2620 and the first object 2610. In the example of FIG. 27, a visualization 2710 of an animation property transfer is displayed between the first object 2610 and the second object 2620. In some embodiments, the visualization 2710 can comprise the sample icon corresponding to the transferred object property sample.

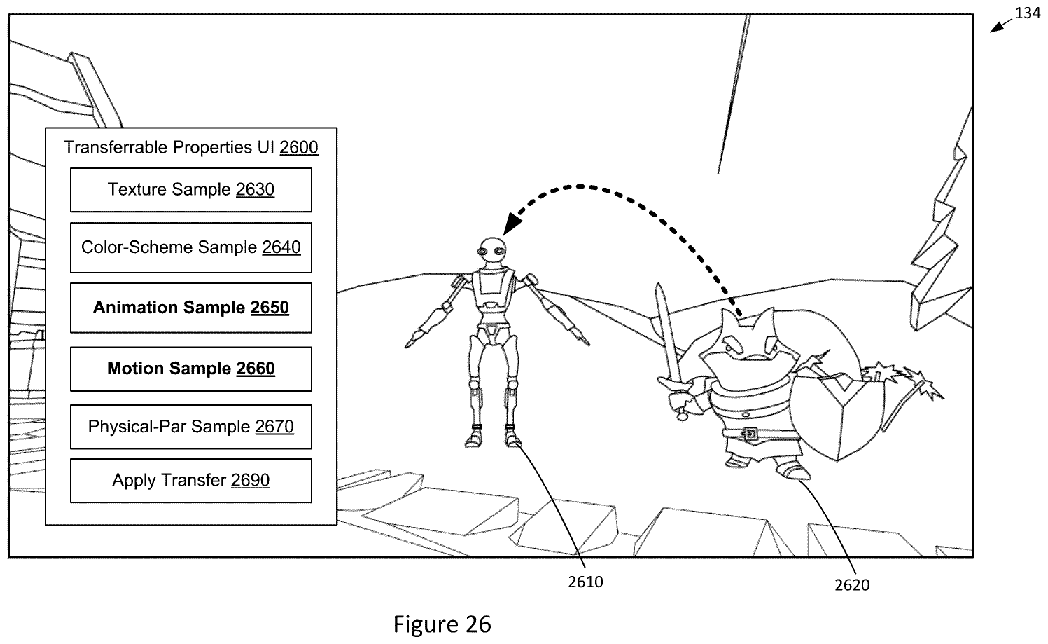

FIG. 28 is a screenshot of a completed animation property transfer to the first object within the remix immersive environment 134 of FIG. 27, according to various embodiments. In some embodiments, the SR engine 140 displays an indication within the remix immersive environment 134 when the property transfer to the first object 2610 is completed. In the example of FIG. 28, the first object 2610 is displayed in darkened or highlighted form to indicate that the animation property transfer has been completed.

Note that a 3D object in the remix immersive environment 134 that is modified with a sample in the SPDS 150 can comprise a new 3D object that is associated with the remix immersive environment 134 (in the associated objects field 220 of the IE entry 230 corresponding to the remix immersive environment 134 in the IE database 180). For example, the modified fox object 2510 comprises a new fox object 2510 and the modified robot object 2810 comprises a new robot object 2810 that are associated with the remix immersive environment 134. Therefore, generating the new fox object 2510 and/or generating the new robot object 2810 associated with the remix immersive environment 134, in turn, generates a new remix immersive environment 134 with new associated objects. As such, modifying an object property of a 3D object using a sample stored to the SPDS 150 can be used to generate a new/modified 3D object as well as a new/modified remix immersive environment 134. Further, any new/modified 3D object generated using a sample in the SPDS 150 can also, in turn, be sampled and added as an entire object sample to the SPDS 150. For example, the new fox object 2510 and/or the new robot object 2810 can be sampled to generate a new fox object sample and/or a new robot object sample in the SPDS 150.

In some embodiments, the color-scheme properties of multiple 3D objects of an IE scene 174 can be modified using a color-palette sample stored to the SPDS 150. In these embodiments, the user can select the color-palette and color-palette collections 1180 from the sample collection menu 1100. In response, the SR engine 140 generates and displays the color-palette and color-palette collections UI 1800 showing a selectable “Global Selection” button 1892 and zero or more color-palette sample icons 1890 representing zero or more color-palette samples stored in the SPDS 150, as described in relation to FIG. 18. The user can then select two or more 3D objects within the remix immersive environment 134 or select the “Global Selection” button 1892 to select all 3D objects displayed in the current IE scene 174 of the remix immersive environment 134.

The user can then select a first color-palette icon 1890 corresponding to a first color-palette sample of a first color-palette stored to the SPDS 150 and drag the first color-palette icon 1890 onto any selected 3D object within the remix immersive environment 134. In response, the SR engine 140 retrieves a first color-palette entry 332 corresponding to the first color-palette icon 1890 in the SPDS 150 and retrieves the color-palette metadata (cpalette_meta) in the sample metadata field 360 of the first color-palette entry 332. Note that the color-palette metadata specifies two or more distinct colors that define the first color-palette. The SR engine 140 then replaces the current color-scheme metadata associated with the two or more selected 3D objects (stored in the associated objects field 220 of the IE entry 230 corresponding to the remix immersive environment 134 in the IE database 180) based on the retrieved color-palette metadata (cpalette_meta) for the first color-palette. The SR engine 140 can do so, for example, by randomly replacing the color-schemes of the two or more selected 3D objects with the two or more distinct colors that define the first color-palette. In this manner, the color-scheme properties of the two or more selected 3D object can be replaced based on the multiple colors of the first color-palette sample to generate two or more new/modified 3D objects and a new/modified remix immersive environment 134.

FIG. 29 is a screenshot of an initiated color-palette remix of multiple objects within the remix immersive environment 134 of FIG. 1, according to various embodiments. In the example of FIG. 29, the remix immersive environment 134 comprises a user-selected remix immersive environment 134 comprising a simulated office park environment. As shown, the remix immersive environment 134 comprises a plurality of 3D objects 2910 (such as 2910a, 2910b, 2910c, etc.) that includes objects such as building/structure objects, landscape objects (boulders, trees, vegetation, and the like), and furniture objects. The SR engine 140 has generated and displayed the color-palette and color-palette collections UI 1800 and at least a first color-palette sample icon 1890a representing a first color-palette sample stored in the SPDS 150.

In the example of FIG. 29, the user has selected the “Global Selection” button 1892 to select all 3D objects 2910 displayed in the current IE scene 174 of the remix immersive environment 134. The user has also selected and dragged the first color-palette icon 1890a onto a selected 3D object within the remix immersive environment 134, which initiates the transfer of the first color-palette to all objects in the current IE scene 174 of the remix immersive environment 134. FIG. 30 is a screenshot of a completed color-palette remix of multiple objects within the remix immersive environment 134 of FIG. 29, according to various embodiments. As shown, in response to the user inputs above, the SR engine 140 replaces the color-schemes associated with all the 3D objects displayed in the current IE scene 174 based on the multiple colors defined in the first color-palette sample, such as by randomly replacing the color-schemes of the 3D objects with the two or more distinct colors of the first color-palette. As shown, the remix immersive environment 134 comprises a plurality of new/modified 3D objects 3010 (such as 3010a, 3010b, 3010c, etc.)

In some embodiments, the SR engine 140 also provides a “revisit” function during the remix stage. When selected for a particular sampled 3D object displayed within the remix immersive environment 134, the revisit function allows the user to view the sampling immersive environment 132 from which the selected 3D object was originally sampled. In some embodiments, the revisit function can be mapped to a particular button on the IE controllers 176 to allow the user to easily access the revisit function at any time during the remix stage.

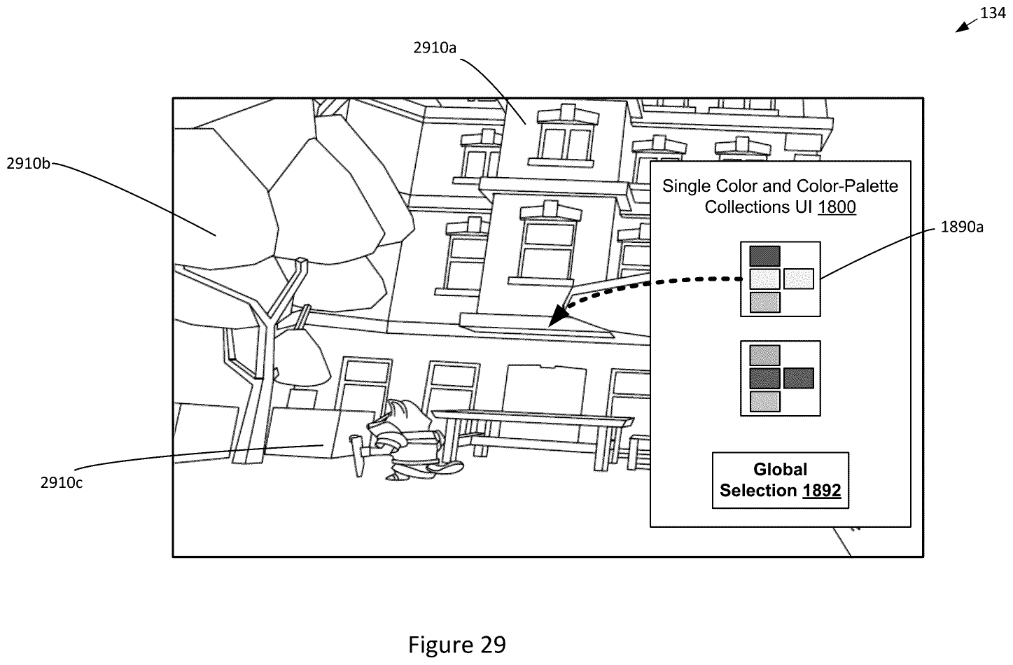

FIGS. 31-33 are screenshots illustrating the operation of the revisit function. FIG. 31 is a screenshot of a sampled chair object 3110 added to the remix immersive environment 134 of FIG. 1, according to various embodiments. In the example of FIG. 31, the chair object 3110 was previously sampled from a particular sampling immersive environment 134. As discussed above, when an object sample of a 3D object is captured within a sampling immersive environment 134, an object entry 304 for the object sample is generated and stored in the SPDS 150. The object entry 304 contains a context field 370 for storing context information that specifies where the 3D object was sampled. In particular, the context field 370 includes an IE identifier 210 of the particular sampling immersive environment 132 from which the 3D object was sampled, the 3D location coordinates of the 3D object within the particular sampling immersive environment 132 when the 3D object was sampled, and the 3D location coordinates of the user viewpoint within the particular sampling immersive environment 132 when the 3D object was sampled.

In the example of FIG. 31, the user has added the chair object 3110 to the remix immersive environment 134 via interactions with the object collection UI 1200, as described in relation to FIG. 22. The user has also selected the revisit function for the chair object 3110 (for example, by selecting the chair object 3110 and selecting a particular button on the IE controllers 176 mapped to the revisit function). In response, the SR engine 140 retrieves the object entry 304 corresponding to the chair object 3110 stored in the SPDS 150 and retrieves the context information from the context field 370 of the object entry 304. The context field 370 specifies an IE identifier 210 of the particular sampling immersive environment 132 from which the chair object 3110 was sampled, and the 3D location coordinates of the chair object 3110 and the user viewpoint within the particular sampling immersive environment 132 when the chair object 3110 was sampled.

The SR engine 140 then initiates the IE engine 110 to render and display at least a portion of the identified sampling immersive environment 132 within the current IE scene 174 based on the retrieved context information in the context field 370. To do so, the IE engine 110 can retrieve an IE entry 230 corresponding to the identified sampling immersive environment 132 (based on the IE identifier field 210) and render and display the identified sampling immersive environment 132 based on the metadata in the associated objects field 220. The IE engine 110 can also render and display the chair object 3110 with a particular user viewpoint within the identified sampling immersive environment 132 based on the 3D location coordinates of the chair object 3110 and the user viewpoint when the chair object 3110 was sampled, as further specified in the context field 370.

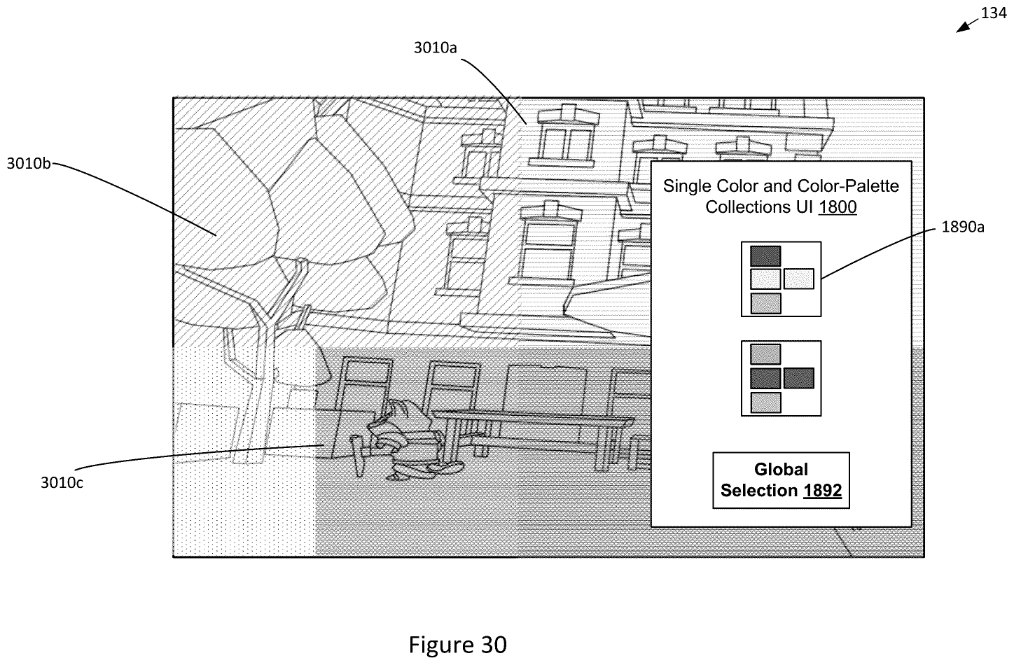

In some embodiments, the revisit function provides a “peek” at the identified sampling immersive environment 132, whereby only a sub-portion of the remix immersive environment 134 of the current IE scene 174 is overlaid with a small sub-portion of the identified sampling immersive environment 132. FIG. 32 is a screenshot of a “peek” revisit function applied to the sampled chair object 3110 of FIG. 31, according to various embodiments. As shown, a sub-portion of the identified sampling immersive environment 132 is rendered and displayed within a sub-portion 3120 of the remix immersive environment 134 of the current IE scene 174. Thus, in the IE scene 174 currently displayed in the IE headset 172, both the remix immersive environment 134 and the identified sampling immersive environment 132 are displayed simultaneously, whereby only a sub-portion 3120 of the remix immersive environment 134 is overlaid by a sub-portion of the identified sampling immersive environment 132.

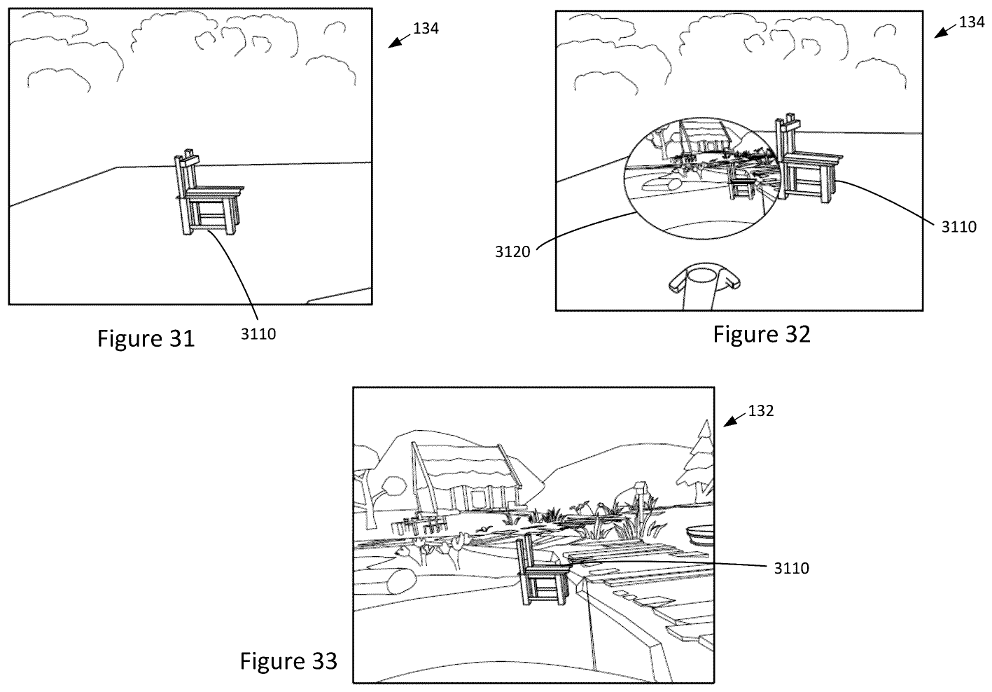

In other embodiments, the revisit function provides a “full immersion” of the identified sampling immersive environment 132, whereby the entire remix immersive environment 134 of the current IE scene 174 is replaced with the identified sampling immersive environment 132. FIG. 33 is a screenshot of a “full immersion” revisit function applied to the sampled chair object 3110 of FIG. 31, according to various embodiments. As shown, the identified sampling immersive environment 132 entirely replaces the remix immersive environment 134 in the current IE scene 174. Thus, in the IE scene 174 currently displayed in the IE headset 172, the remix immersive environment 134 is no longer displayed and only the sampling immersive environment 132 is displayed.

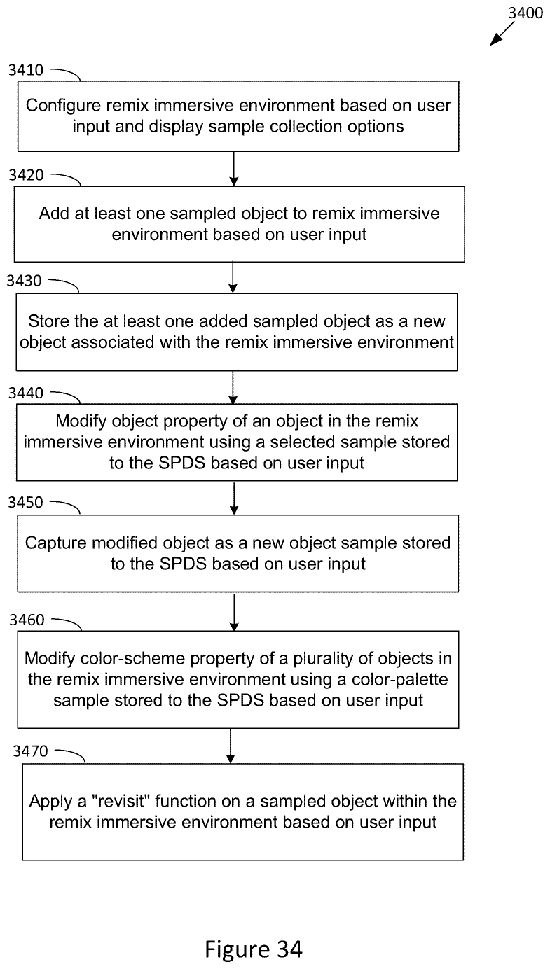

FIG. 34 sets forth a flow diagram of method steps for reusing samples within a 3D immersive environment, according to various embodiments. Although the method steps are described in conjunction with the systems of FIGS. 1-18 and 20-33, persons skilled in the art will understand that the method steps can be performed in any order by any system. In some embodiments, the method 3400 can be performed by the computer system 106 (via the memory unit 104 and processor 102) of the IE system 100 of FIG. 1.

The method 3400 begins when the SR engine 140 configures (at step 3410) a remix immersive environment 134 for a remix stage based on user input. The user input can be received by the SR engine 140 for a default or user-selected remix immersive environment 134. In response, the SR engine 140 retrieves the selected remix immersive environment 134 from the IE database 180 and initiates the IE engine 110 to render and display the remix immersive environment 134 on the IE headset 172. The remix immersive environment 134 can comprise one or more native 3D objects 2110. The SR engine 140 also generates and displays the sample collection menu 1100 of the SPUI 166 within the remix immersive environment 134 for selecting from an object collection 1120, a texture collection 1130, color-scheme collection 1140, animation collection 1150, motion collection 1160, physical-parameters collection 1170, or a single-color and color-palette collection 1180.

At step 3420, the SR engine 140 adds at least one sampled 3D object to the remix immersive environment 134 based on user input. The user input can include a user selection of the object collection 1120 from the sample collection menu 1100. In response, the SR engine 140 generates and displays the object collection UI 1200 and populates the icon window 1110 with object sample icons 1250 representing object samples stored in the SPDS 150, as described in relation to FIG. 12. As described in relation to FIG. 22, the user input can also include a selection of at least one icon 1250 corresponding to at least one sampled object from the object collection UI 1200. In response, the SR engine 140 retrieves the object entry 304 from the SPDS 150 corresponding to the selected icon 1250, and renders and displays the at least one sampled object within the remix immersive environment 134 based on the sample metadata 360 stored in the retrieved object entry 304. Adding the at least one sampled object to the remix immersive environment 134 in this manner generates a new/modified remix immersive environment 134.

At step 3430, the SR engine 140 stores the at least one added sampled object as a new object associated with the remix immersive environment 134. The SR engine 140 can do so by accessing the IE entry 230 corresponding to the remix immersive environment 134 in the IE database 180 and adding the object identifier for the at least one added object and its corresponding object metadata (object_meta) to the associated objects field 220 in the IE entry 230. By doing so, the initial remix immersive environment 134 is modified to generate a new remix immersive environment 134 that includes the at least one new added object.

At step 3440, the SR engine 140 modifies at least one object property of at least one 3D object in the remix immersive environment 134 using at least one selected sample stored to the SPDS 150 based on user input. As described in relation to FIGS. 24, 25A, and 25B, the user input can include a selection of a particular collection UI corresponding to a particular object property from the sample collection menu 1100 to view sample icons for samples of the particular object property stored to the SPDS 150. The user can then select and drag a particular sample icon onto the 3D object to replace a current corresponding object property of the 3D object with the sampled object property corresponding to the selected sample icon. As described in relation to FIGS. 26-28, the user input can include dragging a second 3D object onto a first 3D object within the remix immersive environment 134 to transfer one or more object properties of the second 3D object to the first 3D object. The user input further includes selection, via the transferrable properties UI 2600, of one or more object property samples of the second 3D object stored to the SPDS 150, which causes the one or more selected object properties of the second 3D object to be transferred to the first 3D object. The SR engine 140 then replaces the current object property metadata associated with the modified object in the IE database 180 (as stored in the associated objects field 220 of the IE entry 230 corresponding to the remix immersive environment 134) with the object property metadata of the selected sample.

At step 3450, the SR engine 140 captures a modified object as a new object sample stored to the SPDS 150 based on user input. The SR engine 140 can do so by generating a new entry in the SPDS 150 representing the new object sample and filling in one or more data fields 340, 350, 360, 370, and/or 380 for the new entry, as described in relation to FIG. 5.

At step 3460, the SR engine 140 modifies a color-scheme property of a plurality of 3D objects in the remix immersive environment 134 using a color-palette sample stored to the SPDS 150 based on user input. As described in relation to FIGS. 29-30, the user input can include a selection of a plurality of 3D objects (or the “Global Selection” button 1892 to select all objects in the IE scene) within the remix immersive environment 134. The user input can also include a selection of a particular color-palette icon 1890 from the color-palette collection UI 1800 corresponding to a particular color-palette sample stored to the SPDS 150. In response, the SR engine 140 modifies/replaces the current color-scheme metadata associated with the two or more selected 3D objects (stored in the associated objects field 220 of the IE entry 230 corresponding to the remix immersive environment 134 in the IE database 180) based on the color-palette metadata of the selected color-palette sample.

At step 3470, the SR engine 140 applies a “revisit” function on a sampled 3D object within the remix immersive environment 134 based on user input. As described in relation to FIGS. 31-33, the user input can include selections of the “revisit” function and a particular object that was previously sampled from a particular sampling immersive environment 134. In response, the SR engine 140 retrieves the object entry 304 corresponding to the selected object stored in the SPDS 150 and retrieves the context information from the context field 370 of the object entry 304. The context field 370 specifies an IE identifier 210 of the particular sampling immersive environment 132 from which the selected object was sampled, and the 3D location coordinates of the object and the user viewpoint within the particular sampling immersive environment 132 when the object was sampled. The SR engine 140 then initiates the IE engine 110 to render and display at least a portion of the particular sampling immersive environment 132 within the current IE scene 174 based on the retrieved context information in the context field 370. In some embodiments, the revisit function provides a “peek” at the identified sampling immersive environment 132. In other embodiments, the revisit function provides a “full immersion” of the identified sampling immersive environment 132.

In sum, during a sampling stage, a user can explore a sampling immersive environment to capture samples of 3D digital components within the sampling immersive environment. The 3D digital component can include a 3D object that is rendered and displayed within the sampling immersive environment. The 3D digital components can also include specific object-property components that are used to render a 3D object, such as texture, color scheme, animation, motion path, and physical parameters. The 3D digital components are captured as samples that are stored to a sample-palette data structure (SPDS) that collects and organizes the samples. The captured samples can also include single-color samples and color-palette samples. The samples can be viewed and accessed via a sample-palette user interface (SPUI) that displays sample icons representing the samples stored to the SPDS. Sampling suggestions can also be displayed within the sampling immersive environment.

During a remix stage, a user can reuse/apply a sample stored to the SPDS to modify 3D objects, immersive environments, and/or 3D applications in order to generate and render new 3D objects, new immersive environments, and/or new 3D applications. The user can add a sampled object to a remix immersive environment via interactions with the SPUI to modify the remix immersive environment. The user can apply one or more object-based samples to a 3D object displayed within the remix immersive environment via interactions with the SPUI to modify one or more object properties of the 3D object, such as the texture, color scheme, animation, motion path, and/or physical parameters of the 3D object. The user can also apply a color palette sample to multiple 3D objects displayed within the remix immersive environment via interactions with the SPUI to modify the color property of the multiple 3D objects. A revisit function is also provided that enables a user to revisit a sampling immersive environment from which a sampled object was originally sampled.

At least one technical advantage of the disclosed techniques relative to the prior art is that the disclosed techniques enable 3D digital components to be sampled and collected from immersive environments, which was not achievable using prior art approaches. Further, the disclosed techniques enable a designer/user to navigate an immersive environment, select a 3D object or other 3D digital component to be sampled and stored to a sample-palette data structure (SPDS), which can then be accessed via a sample-palette user interface (SPUI). Once accessed, the sampled 3D object or 3D digital component can be reused in or modified and applied to a different immersive environment or 3D application. In this manner, the disclosed techniques do not require a designer to design and generate each 3D object of an immersive environment or 3D application, as is the case with prior art techniques. Thus, the disclosed techniques can substantially reduce the computer resources needed to design and generate the 3D objects included in an immersive environment or 3D application and also can substantially reduce the overall amount of designer time and effort needed to create an immersive environment or 3D application. These technical advantages provide one or more technological improvements over prior art approaches.

Aspects of the subject matter described herein are set out in the following numbered clauses.
1. In some embodiments, a computer-implemented method for capturing one or more samples within a three-dimensional (3D) immersive environment comprises rendering and displaying a first 3D object within a first 3D immersive environment, wherein the first 3D object comprises at least a first component used for rendering and displaying the first 3D object, and capturing the at least first component as a first sample, and storing the first sample within a sample data structure to allow one or more additional operations to be performed on the first sample.
2. The computer-implemented method of clause 1, wherein the first component comprises metadata for a 3D model associated with the first 3D object.
3. The computer-implemented method of clauses 1 or 2, wherein the first component comprises metadata for a first property associated with the first 3D object.
4. The computer-implemented method of any of clauses 1-3, wherein the first property comprises a texture, an animation, a motion path, or a set of physical parameters associated with the first 3D object.
5. The computer-implemented method of any of clauses 1-4, wherein the sample data structure stores a plurality of samples captured from a plurality of different 3D immersive environments.
6. The computer-implemented method of any of clauses 1-5, wherein the sample data structure includes a plurality of entries corresponding to a plurality of samples, each entry has a set of data fields for a corresponding sample, wherein the set of fields includes at least one of a sample identifier field, an associated object field, a sample metadata field, or a sample icon field.
7. The computer-implemented method of any of clauses 1-6, wherein the sample data structure stores a plurality of samples that are viewable and accessible via a sample user interface that displays a plurality of sample icons that visually represent the plurality of samples.
8. The computer-implemented method of any of clauses 1-7, further comprising receiving a selection of a first point within the first 3D immersive environment, in response, capturing a single-color sample associated with the first point, and storing the single-color sample within the sample data structure.
9. The computer-implemented method of any of clauses 1-8, further comprising receiving a selection of a plurality of 3D objects within the first 3D immersive environment, in response, capturing a color-palette sample associated with the plurality of 3D objects, and storing the color-palette sample within the sample data structure.
10. The computer-implemented method of any of clauses 1-9, further comprising displaying at least one sampling suggestion within the first 3D immersive environment, wherein the at least one sampling suggestion comprises at least one of a suggested 3D object, a suggested texture, a suggested animation, a suggested motion path, a suggested set of physical parameters, or a suggested image.
11. In some embodiments, one or more non-transitory computer-readable media include instructions that, when executed by one or more processors, cause the one or more processors to capture one or more samples within a three-dimensional (3D) immersive environment by performing the steps of rendering and displaying a first 3D object within a first 3D immersive environment, wherein the first 3D object comprises at least a first component used for rendering and displaying the first 3D object, and capturing the at least first component as a first sample, and storing the first sample within a sample data structure to allow one or more additional operations to be performed on the first sample.
12. The one or more non-transitory computer-readable media of clause 11, wherein the first component comprises metadata for a 3D model associated with the first 3D object.
13. The one or more non-transitory computer-readable media of clauses 11 or 12, wherein the first component comprises metadata for a first property associated with the first 3D object.
14. The one or more non-transitory computer-readable media of any of clauses 11-13, wherein the first property comprises a texture, an animation, a motion path, or a set of physical parameters associated with the first 3D object.
15. The one or more non-transitory computer-readable media of any of clauses 11-14, wherein the sample data structure stores a plurality of samples captured from a plurality of different 3D immersive environments.
16. The one or more non-transitory computer-readable media of any of clauses 11-15, wherein the sample data structure stores a plurality of samples of a plurality of different sample types, wherein the plurality of samples are organized within the sample data structure based on sample type.
17. The one or more non-transitory computer-readable media of any of clauses 11-16, wherein the sample data structure stores a plurality of samples that are viewable and accessible via a sample user interface that displays a plurality of sample icons that visually represent the plurality of samples.
18. The one or more non-transitory computer-readable media of any of clauses 11-17, wherein the first 3D object comprises a sub-portion of a second 3D object that was deconstructed into a plurality of sub-portions within the first 3D immersive environment, the plurality of sub-portions including the first 3D object.
19. The one or more non-transitory computer-readable media of any of clauses 11-18, wherein the first sample comprises object metadata for rendering the first 3D object, further comprising rendering and displaying a second 3D immersive environment, and modifying the second 3D immersive environment by applying the first sample within the second 3D immersive environment to render and display the first 3D object within the second 3D immersive environment.
20. In some embodiments, a computer system comprises a memory that includes instructions, and at least one processor that is coupled to the memory and, upon executing the instructions, capture one or more samples within a three-dimensional (3D) immersive environment by performing the steps of rendering and displaying a first 3D object within a first 3D immersive environment, wherein the first 3D object comprises at least a first component used for rendering and displaying the first 3D object, and capturing the at least first component as a first sample, and storing the first sample within a sample data structure to allow one or more additional operations to be performed on the first sample.

Any and all combinations of any of the claim elements recited in any of the claims and/or any elements described in this application, in any fashion, fall within the contemplated scope of the present embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUIs, etc.) are, in various embodiments, stored in the memory/memories shown in the relevant system figure(s) and executed by the processor(s) shown in those same system figures.

Any combination of one or more computer readable medium(s) can be utilized. The computer readable medium can be a computer readable signal medium or a computer readable storage medium. A computer readable storage medium can be, for example, but not limited to, an electronic, non-transitory, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for capturing one or more samples within a three-dimensional (3D) immersive environment, the method comprising:
rendering and displaying a first 3D object within a first 3D immersive environment, wherein the first 3D object comprises at least a first component used for rendering and displaying the first 3D object; and
capturing the at least first component as a first sample; and
storing the first sample within a sample data structure to allow one or more additional operations to be performed on the first sample.

2. The computer-implemented method of claim 1, wherein the first component comprises metadata for a 3D model associated with the first 3D object.

3. The computer-implemented method of claim 1, wherein the first component comprises metadata for a first property associated with the first 3D object.

4. The computer-implemented method of claim 3, wherein the first property comprises a texture, an animation, a motion path, or a set of physical parameters associated with the first 3D object.

5. The computer-implemented method of claim 1, wherein the sample data structure stores a plurality of samples captured from a plurality of different 3D immersive environments.

6. The computer-implemented method of claim 1, wherein the sample data structure includes a plurality of entries corresponding to a plurality of samples, each entry has a set of data fields for a corresponding sample, wherein the set of fields includes at least one of a sample identifier field, an associated object field, a sample metadata field, or a sample icon field.

7. The computer-implemented method of claim 1, wherein the sample data structure stores a plurality of samples that are viewable and accessible via a sample user interface that displays a plurality of sample icons that visually represent the plurality of samples.

8. The computer-implemented method of claim 1, further comprising:
receiving a selection of a first point within the first 3D immersive environment;
in response, capturing a single-color sample associated with the first point; and
storing the single-color sample within the sample data structure.

9. The computer-implemented method of claim 1, further comprising:
receiving a selection of a plurality of 3D objects within the first 3D immersive environment;
in response, capturing a color-palette sample associated with the plurality of 3D objects; and
storing the color-palette sample within the sample data structure.

10. The computer-implemented method of claim 1, further comprising displaying at least one sampling suggestion within the first 3D immersive environment, wherein the at least one sampling suggestion comprises at least one of a suggested 3D object, a suggested texture, a suggested animation, a suggested motion path, a suggested set of physical parameters, or a suggested image.

11. One or more non-transitory computer-readable media including instructions that, when executed by one or more processors, cause the one or more processors to capture one or more samples within a three-dimensional (3D) immersive environment by performing the steps of:
rendering and displaying a first 3D object within a first 3D immersive environment, wherein the first 3D object comprises at least a first component used for rendering and displaying the first 3D object; and
capturing the at least first component as a first sample; and
storing the first sample within a sample data structure to allow one or more additional operations to be performed on the first sample.

12. The one or more non-transitory computer-readable media of claim 11, wherein the first component comprises metadata for a 3D model associated with the first 3D object.

13. The one or more non-transitory computer-readable media of claim 11, wherein the first component comprises metadata for a first property associated with the first 3D object.

14. The one or more non-transitory computer-readable media of claim 13, wherein the first property comprises a texture, an animation, a motion path, or a set of physical parameters associated with the first 3D object.

15. The one or more non-transitory computer-readable media of claim 11, wherein the sample data structure stores a plurality of samples captured from a plurality of different 3D immersive environments.

16. The one or more non-transitory computer-readable media of claim 11, wherein the sample data structure stores a plurality of samples of a plurality of different sample types, wherein the plurality of samples are organized within the sample data structure based on sample type.

17. The one or more non-transitory computer-readable media of claim 11, wherein the sample data structure stores a plurality of samples that are viewable and accessible via a sample user interface that displays a plurality of sample icons that visually represent the plurality of samples.

18. The one or more non-transitory computer-readable media of claim 11, wherein the first 3D object comprises a sub-portion of a second 3D object that was deconstructed into a plurality of sub-portions within the first 3D immersive environment, the plurality of sub-portions including the first 3D object.

19. The one or more non-transitory computer-readable media of claim 11, wherein the first sample comprises object metadata for rendering the first 3D object, further comprising:
rendering and displaying a second 3D immersive environment; and
modifying the second 3D immersive environment by applying the first sample within the second 3D immersive environment to render and display the first 3D object within the second 3D immersive environment.

20. A computer system comprising:
a memory that includes instructions; and
at least one processor that is coupled to the memory and, upon executing the instructions, capture one or more samples within a three-dimensional (3D) immersive environment by performing the steps of:
rendering and displaying a first 3D object within a first 3D immersive environment, wherein the first 3D object comprises at least a first component used for rendering and displaying the first 3D object; and
capturing the at least first component as a first sample; and
storing the first sample within a sample data structure to allow one or more additional operations to be performed on the first sample.
